(19) United States
(12) Patent Application Publication
(10) Pub. No.: US 2019/0158418 A1
(43) Pub. Date: May 23, 2019

(54) EXCHANGE HOSTING SERVER

(71) Applicant: RIPPLE LABS INC., San Francisco, CA (US)

(72) Inventor: Robert Way, Spring, TX (US)

(21) Appl. No.: 15/821,355

(22) Filed: Nov. 22, 2017

(51) Int. Cl. H04L 12/911

(52) U.S. Cl. CPC H04L 47/70

(57) ABSTRACT

Systems and techniques are provided for an exchange hosting server. A request for transfer conditions for a transfer of resources may be received from a first computing device at a second computing device. An exchange participant of a hosted exchange at the second computing device that can complete the transfer of resources may be determined. Transfer conditions may be generated. The transfer conditions may include a path including a first sub-transfer and a second sub-transfer. The first sub-transfer may transfer a first resource type from a first resource pool to a second resource pool on the first computing device. The second sub-transfer may transfer a second resource type from a third resource pool to a fourth resource pool on the second computing device. The second and third resource pool may be controlled by the exchange participant. The transfer conditions may be sent to the first computing device.

### BACKGROUND

The transfer of resources between two parties may use multiple resource types. This may result in additional parties being involved in a transfer in order to effect a change of resource types during the transfer. Additional communication between parties may be required to successfully set up the transfer. Certain parties to the transfer may have limited visibility to the parties responsible for effecting the change of resource types, and the parties that change resource types may be required to be able to effect a change from one resource type to another in both directions.

### BRIEF SUMMARY

In an implementation, a request for transfer conditions for a transfer of resource may be received from a first computing device at a second computing device. An exchange participant of a hosted exchange at the second computing device that can complete the transfer of resources may be determined. A set of transfer conditions may be generated in response to the request for transfer conditions. The set of transfer conditions may include a path including a first sub-transfer and a second sub-transfer. The first sub-transfer may include a transfer of a first resource type from a first resource pool to a second resource pool on the first computing device. The second sub-transfer may include the transfer of a second resource type from a third resource pool to a fourth resource pool on the second computing device. The second resource pool and third resource pool may be controlled by the exchange participant. The set of transfer conditions may be sent to the first computing device.

Systems and techniques disclosed herein may allow for an exchange hosting server. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for an exchange hosting server according to an implementation of the disclosed subject matter.

FIG. 2 shows an example system suitable for an exchange hosting server according to an implementation of the disclosed subject matter.

FIG. 3 shows an example system suitable for an exchange hosting server according to an implementation of the disclosed subject matter.

FIG. 4 shows an example system suitable for an exchange hosting server according to an implementation of the disclosed subject matter.

FIG. 5 shows an example arrangement suitable for an exchange hosting server according to an implementation of the disclosed subject matter.

FIG. 6 shows an example arrangement suitable for an exchange hosting server according to an implementation of the disclosed subject matter.

FIG. 7 shows an example arrangement suitable for an exchange hosting server according to an implementation of the disclosed subject matter.

FIG. 8 shows an example arrangement suitable for an exchange hosting server according to an implementation of the disclosed subject matter.

FIG. 9 shows an example arrangement suitable for an exchange hosting server according to an implementation of the disclosed subject matter.

FIG. 10 shows an example arrangement suitable for an exchange hosting server according to an implementation of the disclosed subject matter.

FIG. 11 shows an example arrangement suitable for an exchange hosting server according to an implementation of the disclosed subject matter.

FIG. 12A shows an example arrangement suitable for an exchange hosting server according to an implementation of the disclosed subject matter.

FIG. 12B shows an example arrangement suitable for an exchange hosting server according to an implementation of the disclosed subject matter.

FIG. 12C shows an example arrangement suitable for an exchange hosting server according to an implementation of the disclosed subject matter.

FIG. 13 shows an example procedure suitable for an exchange hosting server according to an implementation of the disclosed subject matter.

FIG. 14 shows an example procedure suitable for an exchange hosting server according to an implementation of the disclosed subject matter.

FIG. 15 shows a computer according to an embodiment of the disclosed subject matter.

FIG. 16 shows a network configuration according to an embodiment of the disclosed subject matter.

### DETAILED DESCRIPTION

According to embodiments disclosed herein, an exchange hosting server may allow for a resource tracking computing device to host an exchange which allows for the effecting of a change from one resource type to another during a transfer. Participants in the exchange may be able to participate while only offering to effect a change of resource types between a pair of resources in one direction. Exchange participants may join exchanges on resource tracking systems that may be exchange hosting servers. Exchange participants may set their own exchange rates for effecting the change from one resource type to another. The exchange participants may be able to join exchanges by offering to effect a change from a first resource type to a second resource type, and may not need to offer to effect a change from the second resource type back to the first resource type. This may allow resource tracking systems to offer the ability to effect changes of a resource type during a transfer without requiring that a party that controls the resource tracking system make resources available for such changes while allowing the party that controls the resource tracking system to have full visibility of the resources controlled by exchange participants that are available to effect such changes and of the rates of exchange offered by the exchange participants. Transfers that require a change of resource type may be routed through resource tracking systems which host exchanges that can deliver the appropriate change of resource type.

A party, such as, for example, a sending party, exchange participant, or receiving party, may control a resource pool on a resource tracking system. A resource tracking system may be any suitable computing device or system, with any suitable combination of hardware and software, such as, for example, a system run by a financial institution, a hardware or software component of a server system or computing device, or a distributed system, such as, for example, a cryptocurrency ledger or blockchain which may exist on a number of different computing devices and be reconciled in a collaborative fashion, or may be centralized. For example, the resource tracking system be a server system or other computing system that tracks a ledger for a branch of a bank, and may track the control of all accounts opened at that branch. A resource tracking system may track the control of resources for any number of parties. A party, such as, for example, a sending party, exchange participant, or receiving party, may control a resource pool on a resource tracking system. The resource pool for a party on a resource tracking system may include an identification of the party and quantities of each type of resource controlled by the party and tracked by the resource tracking system. A party may have more than one resource type tracked by an individual resource tracking system

For example, a resource tracking system that includes a blockchain for a cryptocurrency may include a resource pool for each party, for example, individual or organization, which owns some quantity of the cryptocurrency. The resource pool may identify the owner of the cryptocurrency, for example, using a cryptographic public key stored with the resource pool, rendering the cryptocurrency accessible only to a party with the corresponding private key. The resource pool may also include the quantity of cryptocurrency. A resource tracking system for a financial institution may include a ledger, for example, hosted on a server system. The resource pools may be accounts owned by account holders at the financial institution, and may track the various assets owned by the account holder and tracked by the financial institution. For example, a resource pool for a party may include a type and quantity of one or more currencies and types and quantities of other types of assets, such as stocks, bonds, certificates of deposit, and the like. Alternatively or in addition, resource pools may include and record ownership of other resources, such as commodities or any resource that may be commoditized, finished physical goods, raw materials, computing resources, real property, or any other resource that may be owned by an entity and transferred from one entity to another. The account holder may be identified by any suitable information, and may need proof of identity, such as, for example, a username and password for the account, in order to access the account. A resource tracking system for a server system may be, for example, some suitable combination of hardware and software for tracking resources and ownership of those resources on the server system. For example, the resource tracking system for a server system may track computing resources such as storage space or processor time owned by various users of the server system, where the users may be physical individuals or organizations, or virtual users of a system, such as system accounts, or other processes running on the server system.

A resource tracking system may track any type of resource. For example, a resource may be a currency, cryptocurrency, financial instrument, commodity, or computational resource such as processor time, volatile and non-volatile storage space, and network bandwidth. The record of ownership and quantity of a resource by the resource tracking system may also be the resource itself, or may be a record of ownership of a resource that exists separately. For example, in a resource tracking system that is a blockchain for a cryptocurrency, the record of ownership for some quantity of the cryptocurrency may be the cryptocurrency. In a resource tracking system that tracks ownership of commodities, the record of ownership may correspond to physical resources, for example, gold, oil, or other commodities, that exist separately. Such resources may be transferred by transferring ownership, though the physical instantiation of the resource may not necessarily be moved.

A resource tracking system may be an exchange hosting server. An exchange participant may be any suitable party which may be an intermediary party in resource transfers which involve more than one resource tracking system. The exchange participant may control resource pools on two or more resource tracking systems, at least one of which may host an exchange. A resource tracking system that is an exchange hosting server may receive exchange participant data from an exchange participant that controls a resource pool on the resource tracking system. The exchange participant data may indicate the rates offered by the exchange participant for effecting a change from a resource type to another resource type that is tracked in a resource pool at the resource tracking system that is an exchange hosting server. The exchange participant may offer to effect a change of resource type from any resource type in a resource pool controlled by the exchange participant on any resource tracking system to any resource type in a resource pool controlled by the exchange participant on the resource tracking system is the exchange hosting server that has received the exchange participant data. The exchange participant data provided by an exchange participant to a resource tracking system that is an exchange hosting server may indicate the other resource tracking systems on which the exchange participant controls a resource pool and the resource types tracked by those resource pools.

An exchange participant may offer to effect a change of resource type in one direction, or in both directions. Effecting a change of resource types in both directions may not be required for an exchange participant to participate in a hosted exchange on a resource tracking system. For example, an exchange participant may control resource pools on two resource tracking systems. The resource pool on the first resource tracking system may track a first resource type, and the resource pool on the second resource tracking system may track a second resource type. The exchange participant may provide exchange participant data to the second resource tracking system, which may be an exchange hosting server. The exchange participant data may indicate the rates at which the exchange participant is willing to effect a change from the first resource type to the second resource type. The exchange participant may not need to provide exchange participant data to the first resource tracking system, which may or may not be an exchange hosting server, indicating rates at which the exchange participant is willing to effect a change from the second resource type to the first resource type. The exchange participant may do so optionally if the first resource tracking system is an exchange hosting server. This may allow an exchange participant the option of offering to effect a change of resource type in one direction or in both directions.

A resource tracking system which is an exchange hosting server may include components to enable the hosted exchange. For example, the resource tracking system may include a component, implemented using any suitable hardware and software, which may manage a hosted exchange on the resource tracking system. Exchange participant data may be received from exchange participants and stored on the resource tracking system hosting an exchange. The exchange participant data may be stored as exchange data in any suitable storage accessible to the resource tracking system. Resource pools controlled by exchange participants may be stored along with other resource pools on the resource tracking system, or may be stored separately from other resource pools. The resource tracking system may be able to access the exchange data, and exchange participant data stored therein, along with the resource pools controlled by exchange participants, in order to provide data about rates offered by various exchange participants and the quantity of resources in resource pools controlled by the exchange participants. The resource tracking system may be able to provide data about rates and resource quantities for various exchange participants without needing to communicate with the exchange participants after exchange participant data for the exchange participants has been received at stored. This may reduce the amount of communication needed during a transfer of resources, as systems used by the exchange participants that have previously sent out exchange participant data may not need to be communicated with when the exchange participant data is used to set up a transfer of resources.

The component of the resource tracking system that manages the hosted exchange may be accessible through exchange clients used by exchange participants. The exchange participants may be, for example, any suitable person, group, organization, or computer hardware and software, and may use any suitable computing devices to communicate with the resource tracking systems. An exchange client may be, for example, any suitable hardware and software on a computing device used by an exchange participant which may allow for interaction with the component of the resource tracking system that manages the hosted exchange. For example, the exchange client may be a specialized application, or may be web-browser interface hosted by the resource tracking computing device or a system connected to the resource tracking computing device. An exchange participant may use their exchange client to submit exchange participant data to any resource tracking systems which are exchange hosting servers and on which the exchange participant controls a resource pool. The exchange participant may send exchange participant data to a resource tracking system at any suitable time, which may allow the exchange participant to makes changes to any exchange participant data previously sent to the resource tracking system. This may allow, for example, an exchange participant to change the rates at which it is willing to effect a change of resource type at any time, or to update a list of resource pools controlled by the exchange participant on other resource tracking systems. The exchange participant data may be changed by, for example, automated systems controlled by the exchange participant.

A party, which may be a sending party, may initiate a transfer of resources by using a client computing device to send a request for transfer conditions to a resource tracking system on which the sending party controls a resource pool. The sending party may be any party that wishes to send, or transfer, resources under their control to some other party, for example, a receiving party. The client computing device may be used by, for example, any suitable person, group, organization, or computer hardware and software, and may be any suitable computing device or system. For example, the client computing device may be a suitable computing device such as a laptop, used by person to initiate a transfer of resources. The client computing device may be used by, for example, a person wishing to transfer currency to another person, business, or organization. The client computing device may be used by the sending party, or may be used on behalf of the sending party. For example, the sending party may be a person, and the client computing device may be a bank computer system, which may be used to initiate a transfer of resources on behalf of the sending party. The client computing device may also be, for example, a server system used by a server management system running on the server system. The client computing device may send the request for transfer conditions, for example, by sending communications over any suitable wired or wireless connection to the connector computing device. The connection may be a network connection, such as a WAN or LAN connection, or may be internal bus connection, for example, within a computing system.

The request for transfer conditions may include an intended receiving party for the transfer of resources, including an identification of the resource pool into which resources are to be transferred, which may a destination resource pool for the transfer, the resource pool out of which resources will be transferred to start the transfer, which may be an origin resource pool for the transfer, the type of resource to be transferred out from the origin resource pool, which may be an origin resource for the transfer, the type of resource to be received in the destination resource pool, which may be a destination resource for the transfer and may be of a different type from the origin resource, and the quantity of the destination resource to be transferred to the destination resource pool. The destination resource pool may be controlled by or otherwise associated with the receiving party and located on a destination resource tracking system for the transfer. The origin resource pool may be controlled by or otherwise associated with the sending party and located on an origin resource tracking system for the transfer. The origin resource tracking system and destination resource tracking system for the same transfer may be different resource tracking systems.

For example, a sending party may wish to transfer money to a receiving party, and may have US dollars to transfer. The receiving party may expect to receive Euros. The sending party, when sending a request for transfer conditions, may specify that it will send out a quantity of US dollars, and the receiving party will receive some quantity of Euros based on exchange rates throughout the transfer and any fees that may be imposed on the transfer. The sending party may, alternatively, specify that the receiving party should receive some quantity of Euros, and the request for transfer conditions may include a request for an indication of the quantity of US dollars the sending party will need to send out to ensure that the receiving party receives the specified quantity of Euros, accounting for exchange rates and fees.

The request for transfer conditions from the client computing device may be received by the origin resource tracking system for the transfer, or by a computing device or system that is associated with, and operates in conjunction with, the origin resource tracking system. For example, the resource pool controlled by the sending party may be an account on the ledger of a branch of a bank. The origin resource tracking system may be, for example, a server belonging to a bank or other financial institution. The origin resource tracking system may include any suitable hardware and software which may handle communication with the client computing device and other resource tracking systems. The origin resource tracking system may receive the request for transfer conditions, for example, over any suitable wired or wireless connection to the connector computing device. The connection may be a network connection, such as a WAN or LAN connection, or may be internal bus connection, for example, within a computing system.

The destination resource pool indicated in the request for transfer conditions may be located on a destination resource tracking system, which may be different from the origin resource tracking system. For example, the sending party may have an account on a ledger at a branch of a first bank. The destination resource pool controlled by the receiving party may be an account on a ledger of a different branch of the same bank, or a branch of a different bank. A transfer between accounts at the different branch of the same bank, or branch of the different bank, may need to occur to complete the transfer to the account of the receiving party.

Additional resource tracking systems may be needed to complete the transfer specified in the request for transfer conditions. For example, there may be no exchange participant of the hosted exchange at the destination resource tracking system that offers to effect a change from the origin resource to the destination resource as they are specified in the request for transfer conditions, or there may be no exchange participant at the destination resource tracking system controlling a resource pool on the origin resource tracking system. A resource tracking system that hosts an exchange with an exchange participant that controls a resource pool on the origin resource tracking system and on which an exchange participant of the destination resource tracking system also controls a resource pool may be used to complete the transfer. Some transfers may need more than one additional resource tracking system.

The origin resource tracking system, on receiving a request for transfer conditions, may send the request for transfer conditions to the destination resource tracking system. The destination resource tracking system may be specified in the request for transfer conditions or may be otherwise determined based on the destination resource pool specified in the request for transfer conditions. The request for transfer conditions may be sent to the destination resource tracking system in any suitable manner, using any suitable communications protocol. The destination resource tracking system may determine whether an additional resource tracking system is needed in order to complete the transfer as specified in the request for transfer conditions. The destination resource tracking system may check the exchange participant data for all exchange participants of the destination resource tracking system to determine if any of the exchange participants both control a resource pool on the origin resource tracking system specified in the request for transfer conditions and have a large enough quantity of the destination resource in a resource pool on the destination resource tracking system to complete the transfer. If at least one of the exchange participants of the destination resource tracking system meets these criteria, the transfer specified in the request for transfer conditions may be completed with just the origin resource tracking system and the destination resource tracking system. If no exchange participant meets these criteria, an additional resource tracking system may be required in order to complete the transfer specified in the request for transfer conditions.

When no additional resource tracking systems are needed to complete the transfer, the destination resource tracking system may generate a set of transfer conditions. A set of transfer conditions may include any suitable conditions for a transfer of resources from the origin resource pool to the destination resource pool. For example, the set of transfer conditions may include identities of a number of resource tracking systems, and parties affiliated with the resource tracking systems, that may be used in the resource transfer, resource pools, and parties that control the resource pools, that may be used in the resource transfer, a quantity of the origin resource that the sending party may need to transfer out to ensure that the receiving party receives the appropriate quantity of the destination resource, any fee for the transfer, and any intermediate resource types and quantities that may be used in the transfer. For example, the set of transfer conditions generated by the destination resource tracking system may include an identification of the exchange participants that both control a resource pool on the origin resource tracking system and have a large enough quantity of the destination resource in a resource pool on the destination resource tracking system to complete the transfer. The set of transfer conditions may specify, for each such exchange participant, the rate at which the exchange participant is willing to effect the change from the origin resource to the destination resource, for example, as an exchange rate that may be supplemented with additional fees. The rate for an exchange participant may determine the quantity of the origin resource that will need to be transferred to the resource pool controlled by the exchange participant on the origin resource tracking system in order for the appropriate quantity of the destination resource to be transferred from the resource pool controlled by the exchange participant to the destination resource pool.

The set of transfer conditions may include conditions for sub-transfers. A sub-transfer may specify a source resource pool, out of which a quantity of resources is transferred, and a sink resource pool, into which the quantity of resources is transferred. The source resource pool and sink resource pool for a sub-transfer may always be on the same resource tracking system as each other. The set of transfer conditions may include a pair of sub-transfers for each exchange participant identified in the set of transfer conditions when no additional resource tracking systems are needed for the transfer. The first sub-transfer for an exchange participant may be an origin sub-transfer, and may specify a transfer of the origin resource out of the origin resource pool on the origin resource tracking system, which may be a source resource pool for the origin sub-transfer. The origin resource may be transferred into a resource pool on the origin resource tracking system, which may be a sink resource pool for the origin sub-transfer. The sink resource pool may be controlled by the exchange participant of the hosted exchange on the destination resource tracking system. The second sub-transfer for an exchange participant may be a destination sub-transfer, and may specify the transfer of the destination resource out of a resource pool controlled by the exchange participant on the destination resource tracking system, which may be a source resource pool for the destination sub-transfer. The destination resource may be transferred into the destination resource pool on the destination resource tracking system, which may be the sink resource pool for the destination sub-transfer. Each pair of sub-transfers may represent an offer to complete the transfer from an exchange participant of the hosted exchange at the destination resource tracking system, and may identify the exchange participant, the resource pools controlled by the exchange participant on the destination resource tracking system and the source resource tracking system and the type of resources they track, and any exchange rates and fees set by the exchange participant in their exchange participant data. The set of transfer conditions may also include any data provided in the request for transfer conditions that was sent by the client computing device. The set of transfer conditions may also include an expiration, which may set a time limit on how long the client computing device will have to accept the set of transfer conditions before they can no longer be accepted.

For example, the set of transfer conditions may include an origin resource of US dollars and a destination resource of Euros. The origin resource pool may be an account on a ledger of a branch of a US bank. The destination resource pool may be an account on a ledger of a branch of a European bank. The branch of the European bank may run a server system that may be an exchange hosting server with several exchange participants. Four of the exchange participants at the European bank branch may have accounts on the ledger of the branch of the US bank, and may have enough Euros in an account at the branch of the European bank to complete the transfer as specified in the request for transfer conditions. The set of transfer conditions may include four pairs of sub-transfers, one for each exchange participant, with each pair of sub-transfers including a first sub-transfer, which may an origin sub-transfer, and second sub-transfer, which may be destination sub-transfer. Each pair of sub-transfers may be a path for the transfer. The first sub-transfer for an exchange participant may specify a transfer of US dollars from the account that is the origin resource pool, for example, an account belonging to the sending party, to an account belonging to the exchange participant on the ledger of the branch of the US bank. The second sub-transfer for the exchange participant may specify a transfer of Euros from an account belonging to the exchange participant on the ledger of the branch of the European bank to the account that is the destination resource pool. The set of transfer conditions may include the rate of exchange, and any additional fees, for each sub-transfer pair based on the exchange participant data for each exchange participant at the European bank. The sending party may select which of the sub-transfer pairs, or paths, and which exchange participant, to use for the transfer. This may allow the sending party to send out US dollars while the receiving party receives Euros, may give the sending party a choice of exchange rates from among the exchange participants at the European bank branch, and may allow for completion of the transfer without requiring any US dollars leave the US bank branch or any Euros leave the European bank branch. It may also allow the European bank branch to be aware of exchange activity taking place in accounts on the ledger of the European bank branch. The quantity of US dollars in the origin sub-transfer may be based on the desired quantity of Euros to be transferred to the account that is the destination resource pool, the exchange rate offered by the exchange participant of the European bank branch to effect a change from US dollars to Euros, and any fees that may be imposed by the exchange participants or US or European bank branches.

When additional resource tracking systems are needed for the transfer of resources, the destination resource tracking system may, after receiving the request for transfer conditions, prepare a partial set of transfer conditions which may be sent along with the request for transfer conditions to any suitable number of additional resource tracking systems. The partial set of transfer conditions may include pairs of sub-transfers for exchange participants that control a resource pool on the destination resource tracking system with a large enough quantity of resources to complete a transfer and control a resource pool on additional resource tracking systems, none of which may be the origin resource tracking system. The first sub-transfer for an exchange participant in a partial set of transfer conditions may be a linking sub-transfer, and may specify a transfer of any suitable quantity of any suitable resource into a resource pool on an additional resource tracking system controlled by the exchange participant of the destination resource tracking system. This resource pool may be a sink resource pool for the linking sub-transfer. The partial set of transfer conditions may not specify the resource pool that is the source resource pool for the linking sub-transfer. This may make the specification of the linking sub-transfer in the partial set of transfer conditions incompletely specified. The second sub-transfer for an exchange participant in a partial set of transfer conditions may be a destination sub-transfer. The second sub-transfer may specify the transfer of a quantity of a destination resource out of a resource pool controlled by the exchange participant on the destination resource tracking system, which may be a source resource pool for the destination sub-transfer. The quantity of the destination resource may be transferred into the destination resource pool. The paths specified in the partial set of transfer conditions may be incomplete paths, and they may include no origin sub-transfer and an incompletely specified linking sub-transfer.

An additional resource tracking system that receives a partial set of transfer conditions and a request for transfer conditions may attempt to complete the partial set of transfer conditions by completing any of the paths. For example, the additional resource tracking system may identify, based on exchange participant data, any exchange participant on the additional resource tracking system that controls a resource pool at the origin resource tracking system and has a large enough quantity of a resource type at the additional resource tracking system to make at least one of the linking sub-transfers incompletely specified in the partial set of transfer conditions. Such an exchange participant may allow for completion of the transfer specified in the request for transfer conditions. The additional resource tracking system may complete the set of transfer of conditions by completing the specification of one of the linking sub-transfers and adding an origin sub-transfer based on exchange participant data for the identified exchange participant.

The additional resource tracking system may complete the partial set of transfer conditions based on the exchange participant data for any exchange participant identified as being able to allow completion of the transfer specified in the request for transfer conditions. For example, the additional resource tracking system may complete the specification of any incompletely specified linking sub-transfers in the partial set of transfer conditions, and may add origin sub-transfers to the partial set of transfer conditions.

The additional resource tracking system may complete the specification of a linking sub-transfer by specifying the resource pool on the additional resource tracking system that can serve as the source resource pool for the linking sub-transfer and the resource type to be transferred if it is not already specified. The resource pool that may serve as the source resource pool for the linking sub-transfer may be a resource pool on the additional resource tracking system controlled by an exchange participant identified as being able to allow completion of the transfer. Any suitable resource type may be used in a linking sub-transfer on an additional resource tracking system. The resource type may be determined based on the resource types tracked in resource pools on the additional resource tracking system if not specified by the linking sub-transfer in the partial set of transfer conditions. The resource type used in a linking sub-transfer may be the same as the origin resource or the destination resource, or may be different from both. The number of completely specified linking sub-transfers may be greater than the number of incompletely specified linking sub-transfers that were in the partial set of transfer conditions received by the additional resource tracking system. For example, if the partial set of transfer conditions includes four incompletely specified linking sub-transfers, and the additional resource tracking system determines that there are three exchange participants that can allow completion of the transfer, the additional resource tracking system may generate as many as twelve completely specified linking sub-transfers. One completely specified linking sub-transfer may be included in a completed set of transfer conditions for every pairing of an exchange participant that can allow completion of the transfer and incompletely specified linking sub-transfer in the partial set of transfer conditions. Each linking sub-transfer may be associated with an appropriate one of the destination sub-transfers that was included in the partial set of transfer conditions as part of a path. For example, a linking sub-transfer may be associated with a destination sub-transfer when the same exchange participant of the destination resource tracking system controls the sink resource pool of the linking sub-transfer and the source resource pool of the destination sub-transfer.

The additional resource tracking system may add origin sub-transfers to the partial set of transfer conditions for each of the exchange participants identified by the additional resource tracking system as being able to allow completion of the transfer. For each such identified exchange participant, the additional resource transfer system may specify an origin sub-transfer where the source resource pool is the origin resource pool on the origin resource tracking system and the sink resource pool is a resource pool on the origin resource tracking system that is controlled by the identified exchange participant. The origin sub-transfer specified for such an identified exchange participant may be associated in the completed set of transfer conditions with any linking sub-transfers which use a resource pool controlled by that exchange participant as part of a path. For example, if the completed set of transfer conditions includes four linking sub-transfers where the source resource pool is controlled by a particular exchange participant at the additional resource tracking device, the origin sub-transfer for that exchange participant may be associated with all four of the linking sub-transfers, forming the parts of four separate paths.

The set of transfer conditions completed by the additional resource tracking system may include a number of options, or paths, for completion of the transfer as specified in the request for transfer conditions. For example, a completed set of transfer conditions that includes three origin sub-transfers, twelve linking sub-transfers, and four destination sub-transfers may provide twelve paths for completion of the transfer, any of which may be selected at the client computing device by the sending party. Each of the paths provided in a set of transfer conditions may have associated rates of exchange for each change of resource effected by the path, as specified by exchange participants in their exchange participant data, along with any fees that may be imposed by the exchange participants or by any of the resource tracking systems.

The partial set of transfer conditions and request for transfer conditions may be sent to any suitable number of additional resource tracking systems. For example, the exchange participant data for an exchange participant on the destination resource tracking system may identify additional resource tracking systems on which that exchange participant controls a resource pool. The partial set of transfer conditions and request for transfer conditions may be sent to any such resource tracking systems identified in the exchange participant data for exchange participants for which the partial set of transfer conditions includes a destination sub-transfer and linking sub-transfer. These may be the resource tracking systems on which the exchange participants that can complete the destination sub-transfer to the destination resource pool on the destination resource tracking system can receive a transfer of resources, allowing for the completion of the linking sub-transfer. The partial set of transfer conditions and request for transfer conditions may be sent to all such identified resource tracking systems, or to some subset of such identified resource tracking systems. The partial set of transfer conditions sent to a resource tracking system may only include destination sub-transfers and linking sub-transfer for exchange participants of the destination resource tracking system which also control a resource pool on that resource tracking system. For example, if the destination resource tracking system generates a partial set of transfer conditions with destination sub-transfers and linking sub-transfers for three exchange participants of the destination resource tracking system, each of which controls a resource pool on a different additional resource tracking system, a partial set of transfer conditions may be sent to each of the three additional resource tracking systems. The partial set of transfer conditions sent to each of the three additional resource tracking systems may include only the linking sub-transfer and destination sub-transfer for the exchange participant that controls a resource pool on that resource tracking system. This may result in the origin resource tracking system receiving multiple completed sets of transfer conditions, all of which may be combined into a single set of transfer conditions before being sent to the client computing device. The client computing device may be used to select a path from the single set of transfer conditions, which may include paths completed by various different additional resource tracking systems.

Any additional resource tracking system that completes a set of transfer conditions based on the received request for transfer conditions and a partial set of transfer conditions may send the completed set of transfer conditions to the origin resource tracking system. The origin resource tracking system may then provide the completed set of transfer conditions to the client computing device so that a path may be selected, or all paths may be declined. The completed set of transfer conditions may be transmitted using any suitable protocol. For example, the sets of transfer conditions may be transmitted between computing devices using HTTP. Each path in a set of transfer conditions may appear separately, such that the client computing device, or party using the client computing device, may be able to evaluate each path. For example, different paths may use a different additional resource tracking systems, different resources in linking sub-transfers, and different exchange participants offering different exchange rates and fees. The client computing device may be used by the sending party to select, if necessary, and accept a path from the set of transfer conditions. When the set of transfer conditions includes only a single path, the client computing device may only be able to accept or reject the path. When the set of transfer conditions includes multiple paths, the client computing device may be able to select and accept one of the paths. The acceptance of a path may be done through automated analysis of any available paths, or the paths may be presented to a representative of the sending party who may select a path through a suitable user interface. Paths which are not accepted may be discarded immediately, or may be maintained to be used in the event the transfer of resources using the selected path fails. Paths which have expired may not be accepted. Each path may include a listing of the exchange rates offered by the exchange participants for the path, any fees imposed on the path, and a total cost of the path so that a sending party may be able to evaluate the relative costs of various paths which use various exchange participants.

For example, the origin resource pool for a transfer may be an account on a ledger at a branch of a US bank, and the origin resource may be US dollars. The destination resource pool for the transfer may be an account on ledger at a branch of a European bank, and the destination resource may be Euros. None of the exchange participants at the branch of the European bank with enough Euros to complete the transfer may have an account at the branch of the US bank. An additional ledger may be required to complete the transfer. The branch of the European bank, upon receiving the request for transfer conditions for the transfer, may generate a partial set of transfer conditions that may include a destination sub-transfer and an incompletely specified linking sub-transfer for each exchange participant at the European bank branch that has enough Euros to complete the transfer. The partial set of transfer conditions, along with the request for transfer conditions, may be sent additional ledgers on which the exchange participants of the European bank branch which can complete the transfer have accounts. The additional ledgers may be, for example, other bank branches, cryptocurrency ledgers, or any other suitable financial institution at which an exchange participant of the European bank branch have accounts. For example, an additional ledger may be cryptocurrency ledger. The cryptocurrency ledger may identify which of its exchange participants both have a large enough quantity of cryptocurrency to complete the transfer and control an account at the US bank branch where the account that is the origin resource pool for the transfer is located. The cryptocurrency ledger may complete the specification of incompletely specified linking sub-transfers in the partial set of transfer conditions, and may add origin sub-transfers to the partial set of transfer conditions, based on the exchange participant data for and accounts of any such exchange participants. This may result in a completed set of transfer conditions, which may be sent to the US bank branch.

The US bank branch may send the completed set of transfer conditions to a computing device used by the sending party for the transfer, to whom the account at the US bank branch that is the origin resource pool belongs. The completed set of transfer conditions may include multiple paths, and the sending party may select a path for the transfer from the available paths in the completed set of transfer conditions. The selected path may include, for example, an origin sub-transfer of US dollars from the account of the sending party at the US bank branch to the account at the US bank branch of the exchange participant of the cryptocurrency ledger, a linking sub-transfer of cryptocurrency from the account at the cryptocurrency ledger of the exchange participant of the cryptocurrency ledger to the account at the cryptocurrency ledger of the exchange participant of the European bank branch, and a destination sub-transfer of Euros from the account at the European bank branch of the exchange participant of the European bank branch to the account at the European bank branch that is the destination resource pool. The quantity of US dollars in the origin sub-transfer may be based on the desired quantity of Euros to be transferred to the account that is the destination resource pool, the exchange rate offered by the exchange participant of the cryptocurrency ledger to effect a change from US dollars to the cryptocurrency, the exchange rate offered by the exchange participant of the European bank branch to effect a change from cryptocurrency to Euros, and any fees that may be imposed by the exchange participants, US or European bank branches, or cryptocurrency ledger.

In some implementations, more than one additional resource tracking system may be needed to complete a transfer. An additional resource tracking system may be unable complete a received partial set of transfer conditions, for example, because no exchange participant of the additional resource tracking system with a large enough quantity of resources to complete the transfer controls a resource pool on the origin resource tracking system. The additional resource tracking system may completely specify any incomplete linking sub-transfers in the partial set of transfer conditions based on the exchange participants that have a large enough quantity of resources to complete the transfer, and may add new incompletely specified linking sub-transfers to the partial set of transfer conditions based on other resource tracking systems on which those exchange participants control resource pools. The partial set of transfer conditions may then be sent to those other resource tracking systems, which may attempt to completely specify the new linking sub-transfers and add origin sub-transfers. This may continue recursively until a resource tracking system is able to complete the set of transfer conditions with at least one path from the origin resource pool to the destination resource pool.

When there is no additional resource tracking system in the path selected for the transfer of resources, the client computing device may send transfer instructions to the origin resource tracking system to use the selected path to execute the transfer. The origin resource tracking system may execute the origin sub-transfer, and may then instruct the destination resource tracking system to execute the destination sub-transfer. In some implementations, the order of execution of the origin sub-transfer and destination sub-transfer may be reversed, for example, with the destination sub-transfer occurring first. In some implementations, the origin sub-transfer and destination sub-transfer may be executed without reference to each other, which may result in, for example, execution at the same time. A resource tracking system may be able to effect the transfer (i.e., cause the transfer to occur) of resources from an origin resource pool to a destination resource pool upon receiving an instruction to execute the transfer. A resource tracking system may transfer resources in any suitable manner. For example, a resource tracking system may modify the quantities of resources recorded as held by the parties which control the resource pools involved in the transfer For example, to transfer resources from a source resource pool to a sink resource pool as specified in a sub-transfer, the resource tracking system may, simultaneously or sequentially, decrease the quantity of the resource recorded as owned by the party which controls the source resource pool and increase the quantity of the resource recorded as controlled by the party which owns the sink resource pool. The quantity of the resource recorded in the source resource pool may be decreased by the same quantity that the quantity of the resource recorded in the sink resource pool is increased. For example, to transfer resources between resource pools which are accounts on a ledger of a bank branch denominated in US dollars, the source resource pool may be decremented by the quantity of US dollars being transferred, and the sink resource pool may be incremented by the same quantity of US dollars.

Each resource tracking system in a path selected from a set of transfer conditions may effect a transfer of resources based on the sub-transfer in the path with a source and sink resource pool on that resource tracking system. The execution of the origin sub-transfer on the origin resource system may transfer the quantity of the origin resource for the transfer from the origin resource pool on the origin resource tracking system to a sink resource pool that is both on the origin resource tracking system and is controlled by an exchange participant of the destination resource tracking system. The execution of the destination sub-transfer may transfer the quantity of the destination resource specified in the path from the set of transfer conditions from a source resource pool that is on the destination resource tracking system and is controlled by the exchange participant of the destination resource tracking system to the destination resource pool on the destination resource tracking system.

When there is an additional resource tracking system in the path selected for the transfer of resources, the client computing device may send transfer instructions to the origin resource tracking system to use the selected path to execute the transfer. The origin resource tracking system may execute the origin sub-transfer, and may then instruct the additional resource tracking system that is next in the path to execute the linking sub-transfer for that additional resource tracking system. If there are no other additional resource tracking systems in the path, the additional resource tracking system may instruct the destination resource tracking system to execute the destination sub-transfer. If there is more than one additional resource tracking system in the path, each additional resource tracking system may instruct the next additional resource tracking system in the path to execute the appropriate linking sub-transfer, with the final additional resource tracking system instructing the destination resource tracking system to execute the destination sub-transfer. In some implementations, the order of execution of the origin sub-transfer, any linking sub-transfers, and destination sub-transfer may be reversed, for example, with the destination sub-transfer occurring first, and the linking sub-transfers occurring in reverse of their ordering in the path. In some implementations, the origin sub-transfer, linking sub-transfers, and destination sub-transfer may be executed without reference to each other, which may result in, for example, execution at the same time.

Each resource tracking system in a path selected from a set of transfer conditions may effect a transfer of resources based on the sub-transfer in the path that has its source and sink resource pool on that resource tracking system. The execution of the origin sub-transfer on the origin resource system may transfer the quantity of the origin resource specified in the path from the set of transfer conditions from the origin resource pool on the origin resource tracking system to a sink resource pool that is on the origin resource tracking system and is controlled by an exchange participant of the destination resource tracking system. The execution of a linking sub-transfer may transfer the quantity of the resource for the linking sub-transfer, which may be the origin resource, destination resource, or some other resource, as specified in the path from the set of transfer conditions. The resource for the linking sub-transfer may be transferred from a source resource pool that is on an additional resource tracking system and is controlled by an exchange participant of the previous resource tracking system in the path, which may be the origin resource tracking system or another additional resource tracking system, to the a sink resource pool that is on the additional resource tracking system and is controlled by an exchange participant of the next resource tracking system in the path, which may be another additional resource tracking system or the destination resource tracking system. The execution of the destination sub-transfer may transfer the quantity of the destination resource specified in the path from the set of transfer conditions from a source resource pool that is on the destination resource tracking system and is controlled by the exchange participant of the destination resource tracking system to the destination resource pool on the destination resource tracking system.

In some implementations, multiple exchange participants that control resource pools at the destination resource tracking system for a transfer and do not individually have a large enough quantity of resources to complete the transfer, but have a large enough quantity of resources to complete the transfer in combination with each other, may be used to complete a transfer. For example, there may a first exchange participant that controls a resource pool on the source resource tracking system for a transfer with enough resources for half of the transfer, while a second exchange participant controls a resource pool on the source resource tracking system with enough resources for the other half of the transfer, though not enough to complete the whole transfer itself.

For each such combination of exchange participants, a set of linked paths may be generated. The paths in a set of linked paths generated by the destination resource tracking system may be any suitable combination of complete path and incomplete paths. For example, the destination resource tracking system may generate a set of linked paths with two paths, a first path and a second path corresponding to a first exchange participant and a second exchange participant, respectively. Both linked paths may be complete paths when the exchange participants for the first path and the second path of the set of linked paths control a resource pool on the destination resource tracking system and the source resource tracking system. The set of transfer conditions sent to the client computing device may include the set of linked paths. The linking of the paths may indicate to the client computing device that the requested transfer can be completed by selecting the set of linked paths, but not by selecting either of the paths in the set of linked paths individually. The client computing device may be unable to select individual paths that are part of a set of linked paths, as this may not complete the transfer. Any number of paths may be linked in a set of linked paths, and any number of sets of linked paths may be sent to the client computing device.

A set of linked paths may include any combination of paths that need no extra resource tracking systems and those that need extra resource tracking systems. The destination resource tracking system may, for example, generate a set of linked paths where some of the paths are incomplete, and require an additional resource tracking system to be completed. For example, a first path in a set of linked paths may be for a first exchange participant that controls a resource pool on the destination resource tracking system and the source resource tracking system. This first path may be able to transfer some portion, for example, half of the resources needed to complete the transfer as requested by the client computing device. A second path in the set of linked paths may be for a second exchange participant that controls a resource pool on the destination resource tracking system, but does not control a resource pool on the source resource tracking system. The destination resource tracking system may generate an incomplete path for the second exchange participant, which may be sent as part of a set of partial transfer conditions to other resource tracking system on which the second exchange participant controls a resource pool. An additional resource tracking system device that receives the partial set of transfer conditions may attempt to generate complete the path for the second exchange participant, but may only need to do so for the portion of the resources that are being transferred by the second exchange participant, rather than for all of the resources that were in the original request for transfer conditions sent by the client computing device, as the remainder of the resource may be transferred using the path for the first exchange participant in the set of linked paths. When one of the additional resource tracking systems completes the incomplete path for the second exchange participant, the completed set of transfer conditions, including the completed path for the second exchange participant, may be sent to the source resource tracking system, and passed to the client computing device. The paths for the first and second exchange participants may be rejoined as the set of linked paths at either the source resource tracking system or the client computing device, so that the client computing device may only select the set of linked paths in combination, and may not select the constituent paths of the set of linked paths separately from each other. When a set of linked paths is selected by the client computing device 300, the transfer authorization may authorize all of the paths in the set of linked paths. Transfers across each path may occur sequentially, simultaneously, or with any other suitable relative timing. If a transfer across one of the paths from a set of linked paths fails, the entire transfer may fail, and any transfers made using any other paths in the set of linked paths may be rolled back.

In some implementations, a resource tracking system may be able to transfer specific resources between resources tracking pools. For example, when transferring commodities, a resource tracking system may be able to transfer commodities held at a specific location between resource pools. The resource quantities for a resource with a physical instantiation may also indicate where the physical intention is located. For example, gold may be held at specific storage facility. The resource tracking system may transfer such resources by decrementing and incrementing in both resource pools a quantity of resources located in a particular location. For example, a resource pool may include gold stored at a storage facility and a storage facility B. The resource tracking system may transfer, to another resource pool, only gold from storage facility A. The resource tracking system may decrement the amount of gold recorded as stored at storage facility A in the source resource pool, and increase the amount of gold recorded as stored in storage facility A in the destination resource pool. Specific resources transferred by the resource tracking system may also include, for example, physical items of which there may be one or few copies, such as, for example, artwork including painting, sculptures, and prints, artifacts, collector's items such as sports memorabilia and comic books, jewelry, precious stones, and any other such item, or mass marketed goods, such as smartphones, foodstuffs, and so on.

Communication between the computing devices and systems for the parties may occur directly, for example, between any of the sender, the exchange participants, the receiver and the resource tracking systems, or may be routed in any suitable manner. Communications may occur directly using any suitable communications protocols, such as, for example, HTTPS. In some implementations, instead of messages being sent by one computing device or system to another, a computing device or system may check for a message on another computing device or system. Computing devices and system may communicate using any suitable communications hardware, including, for example, any suitable wired and wireless network adapters.

The exchange participants may be independent from the resource tracking systems. Exchange participants may add, change, and delete their exchange participant data from resource tracking systems that are exchange hosting servers at any suitable time, for example, subject to any restrictions on access imposed by the resource tracking systems. This may allow an exchange participant to adjust their offered rate of exchange at a resource tracking system at will, for example, using an automated process. An exchange participants may or may not be notified when they are included in a set of completed transfer conditions, and may or may not be notified when a sending party has selected a path that includes the exchange participant. Sub-transfers involving resource pools controlled by an exchange participant may be executed without being reviewed by or receiving affirmative approval from the exchange participant. This may allow for faster completion of transfers of resources, as less communication is required to complete the transfer and any waiting time for review and approvals of the sub-transfers in a transfer may be reduced. Rates of exchange offered by exchange participants may be specified in any suitable manner, and may be fixed for all resource quantities, or may vary, for example, with more different exchange rates offered depending on the quantity of resource involved in a transfer.

An exchange participant may participate in the hosted exchanges of any number of resource tracking systems, and may offer to effect changes between any two types of resource, in one or both directions. For example, an exchange participant at branch of a European bank may offer to effect a change from US dollars to Euros, and may have an account on a branch of a US bank that is denominated in US dollars. The exchange participant may offer to effect a change from Euros to US dollars, for example, by being an exchange participant of an exchange hosted at the branch of the US bank, or may not offer to effect a change from Euros to US dollars with no effect on the exchange participant's status as a participant of the hosted exchange at the branch of the European bank.

The use of an exchange hosting servers on resource tracking systems may allow for more efficient transfers of resources using multiple resource tracking systems, without requiring any resources leave any individual resource tracking system. The exchange hosting server may reduce the risk that an exchange participant misrepresents their ability to complete, or participate in completion of, a transfer, as the exchange hosting server being part of the resource tracking system may allow the exchange hosting server to access appropriate data to determine the veracity of rates of exchange offered by an exchange participant and quantities of resources held by exchange participants on the resource tracking system. This may reduce failed transfers, requiring fewer rollbacks, allowing for more efficient use of computational resources. For example, when a resource tracking system is a blockchain, implementing a transfer may require significant use of computational resources, and rolling back a transfer may not be possible, or may require further use of computational resources. An exchange hosting server may allow for more efficient operation of a resource tracking system that is implemented as a centralized or distributed blockchain, as fraudulent or incorrect transfers may occur less frequently, requiring fewer rollbacks of completed blocks, and preventing conditions which may lead to forking of a blockchain.

Additionally, the exchange hosting server may reduce the network communication needed to setup and complete a transfer that uses exchange participants, reducing the use of computational and communication resources and providing additional security for a transfer. The communications in a transfer may be among the client computing device and the resource tracking systems in the transfer, including resource tracking systems that attempt to complete partial sets of transfer conditions. A transfer may be setup without direct communication with exchange participants, who may have separately provided relevant exchange participant data to exchange hosting servers of the resource tracking systems in the transfer. Removing the need to communicate with exchange participants directly during the setup or completion of a transfer may reduce computational and communication resources used for each transfer, and may prevent security issues caused by communication with systems that are not resource tracking systems.

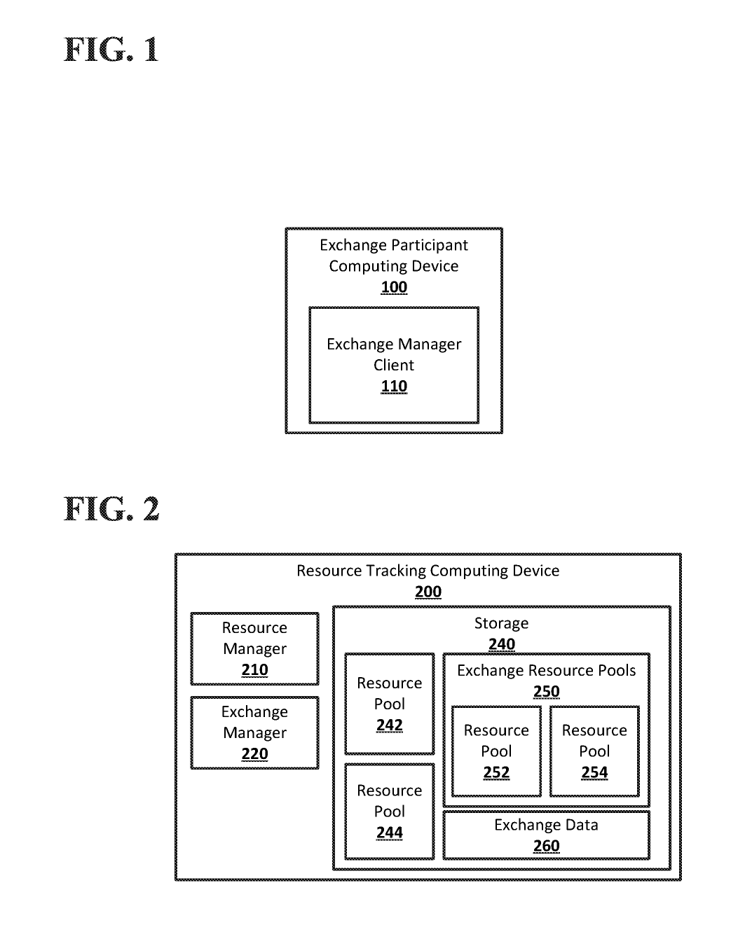

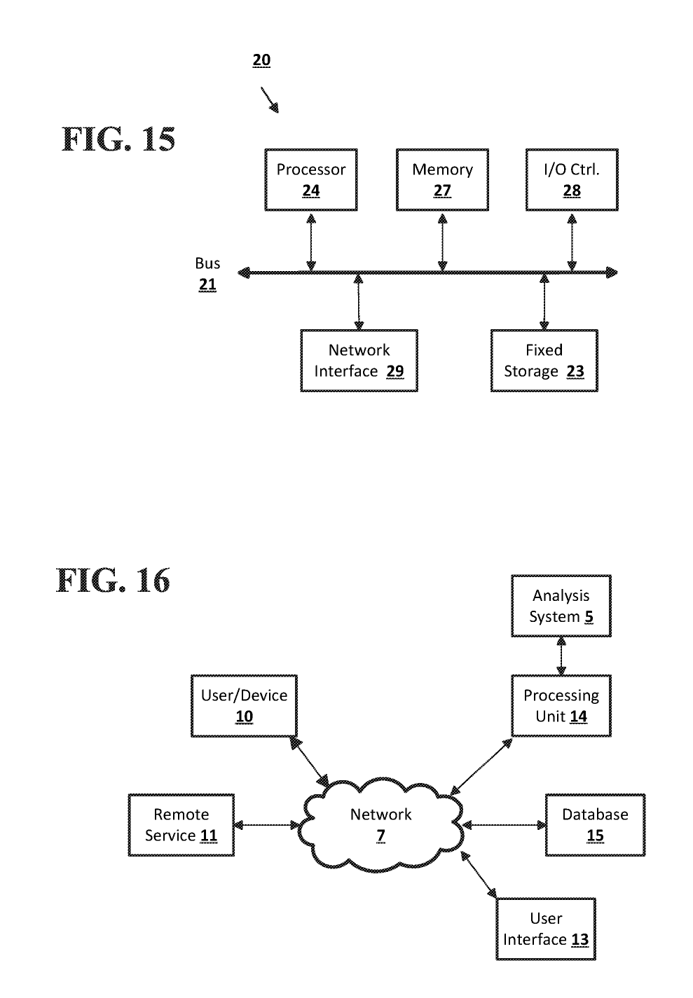

FIG. 1 shows an example system suitable for an exchange hosting server according to an implementation of the disclosed subject matter. An exchange participant computing device 100 may include an exchange manager client 110. The exchange participant computing device 100 may be any suitable computing device, such as, for example, a computer 20 as described in FIG. 15, or component thereof, for implementing the exchange manager client 110. The exchange participant computing device 100 may be a single computing device, or may include multiple connected computing devices, and may be, for example, a laptop, a desktop, an individual server, a server farm, or a distributed server system, or may be a virtual computing device or system. The exchange participant computing device 100 may be part of a computing system and network infrastructure, or may be otherwise connected to the computing system and network infrastructure. The exchange manager client 110 may be any suitable combination of hardware and software on the exchange participant computing device 100 for interacting with an exchange manager on a resource tracking computing device. The exchange participant computing device 100 may be a computing device associated with or used by any suitable party, such as, for example, a trader or financial institution, who offer rates of exchange for effecting changes from one resource type to another resource type.

The exchange manager client 110 may be any suitable combination of hardware and software for interacting with an exchange manager. The exchange manager client 110 may, for example, allow for the sending of exchange participant data to an exchange manager so that it may be stored as part of the exchange data of a resource tracking system that is an exchange hosting server, and for the updating, changing, editing, or deleting of previously sent exchange participant data. For example, an exchange participant may use their exchange manager client 110 to change the rates of exchange they offer on a hosted exchange at a resource tracking system, for example, by updating rates of exchange in previously stored exchange participant data. The exchange manager client 110 may also be used to change which resource types the exchange participant will effect changes between, and to change which directions the exchange participant will effect a change of resource types in. For example, the exchange manager client 110 may indicate to an exchange manager that the exchange participant wishes to withdraw from a hosted exchange on a resource tracking system while still maintaining a resource pool on that resource tracking system. This may result in the exchange participant no longer offering to effect a change on that particular resource tracking system to the resource type tracked in the resource pools of that resource tracking system. The exchange manager client 110 may update exchange participant data to indicate other resource tracking systems on which the exchange participant controls resource pools, adding and removing indications of various resource tracking systems as the resource pools controlled by the exchange participant change. An indication of a resource pool controlled by the exchange participant on one resource tracking system may also be removed from the exchange participant data for the exchange participant on another resource tracking system, if the exchange participant no longer wishes to be involved in a transfer of resource that uses a path through both the one resource tracking system and the another resource tracking system. The exchange manager client 110 may use any suitable communications devices of the exchange participant computing device 100 to communicate with other computing devices, including, for example, any resource tracking system. The exchange manager client 110 may be, for example, software run on the exchange participant computing device 100, and may be an application or may be, for example, a front-end interface to a service hosted on another computing device, allowing access to exchange managers and the features made available by the exchange managers.

FIG. 2 shows an example system suitable for an exchange hosting server according to an implementation of the disclosed subject matter. A resource tracking computing device 200 may include a resource manager 210, an exchange manager 220, and a storage 240. The resource tracking computing device 200 may be any suitable computing device, such as, for example, a computer 20 as described in FIG. 15, or component thereof, for implementing the resource manager 210, the exchange manager 220, and the storage 240. The resource tracking computing device 200 may be a single computing device, or may include multiple connected computing devices, and may be, for example, a laptop, a desktop, an individual server, a server farm, or a distributed server system, or may be a virtual computing device or system. The resource tracking computing device 200 may be part of a computing system and network infrastructure, or may be otherwise connected to the computing system and network infrastructure. The resource tracking computing device 200 may be, for example, a system tracking a ledger for a bank or a branch of a bank, or may be a public cryptocurrency ledger that may distributed or centralized. The resource manager 210 may be any suitable combination of hardware and software on the resource tracking computing device 200 for managing resources belonging to various parties and tracked by the resource tracking computing device 200. The resources may be tracked in resource pools, such as, for example, the resource pools 242 and 244 in the storage 240. The exchange manager 220 may be any suitable combination of hardware and software on the resource tracking computing device 200 for managing an exchange hosted on the resource tracking computing device 200. The storage 240 may store the resource pools, such as the resource pools 242 and 244, for the various parties with resources tracked by the resource tracking computing device 200. The storage 240 may also store exchange resource pools 250, such as the resource pools 252 and 254, which may be resource pools for exchange participants of the hosted exchange at the resource tracking computing device 200. The resource pools 242, 244, 252, and 254 may be records of resources owned by parties and tracked by the resource tracking computing device 200, including the types and quantities of the resources, and an identification of the party that owns or controls the resources in the resource pool. The storage 240 may also store exchange data 260. The exchange data 260 may include any exchange participant data for exchange participants of the hosted exchange at the resource tracking computing device 200. The resource tracking computing device 200 may be a resource tracking system, which may or may not be affiliated with or belong to a particular person or organization, or may be a component of a server system.

The resource manager 210 may be any suitable combination of hardware and software on the resource tracking computing device 200 for managing resources belonging to various parties and tracked by the resource tracking computing device 200. The resource manager 210 may be able to receive transfer instructions, which may indicate that resources tracked by the resource tracking computing device 200 are to be transferred from one resource pool on the resource tracking computing device 200 to another resource pool on the resource tracking computing device 200.

The resource manager 210 may be able to transfer resources between resource pools, such as the resource pool 242 and the resource pool 244, by decrementing the quantity of the resources in one resource pool and incrementing the quantity of the resources in the other resource pool by the same quantity. For example, the resource manager 210 may transfer 100 US dollars from the resource pool 242 to the resource pool 244 by decrementing the quantity of US dollars recorded by the resource pool 242 by 100, and incrementing the quantity of US dollars recorded by the resource pool 244 by 100.

The exchange manager 220 may be any suitable combination of hardware and software on the resource tracking computing device 200 for managing a hosted exchange at the resource tracking computing device 200. The exchange manager 220 may be able to receive exchange participant data, for example, from an exchange client manager such as the exchange client manager 110. The exchange participant data may include, for example, rates of exchange offered by an exchange participant to effect a change of resource types to a resource type tracking by the resource pools, such as the resource pool 252, on the resource tracking computing device 200. The exchange participant data may also include a list with indications of other resource tracking systems on which the exchange participant controls resource pools, and the types of resources tracked in those resource pools. The exchange manager 220 may store the exchange participant data as part of the exchange data 260 in the storage 240. The exchange manager 220 may also update or delete exchange participant data, for example when instructed by an exchange manager client. For example, the exchange manager client 110 may send updated rates of exchange offered by the exchange participant associated with the exchange participant computing device 100. The exchange manager 220 may change the rates of exchange in the exchange participant data stored for the exchange participant as part of the exchange data 260.

The exchange manger 220 may generate partial and complete sets of transfer conditions. For example, the exchange manager 220 may receive a request for transfer conditions in which the resource tracking computing device 200 is the destination resource tracking system, and may determine, based on exchange participant data stored in the exchange data 260, if it can generate a complete set of transfer conditions, or can only generate a partial set of transfer conditions. The exchange manger 220 may, for example, examine the exchange data 260 for an exchange participant that controls a resource pool on the origin resource tracking system for the transfer and has a large enough quantity of resources in its resource pool on the resource tracking computing device 200 to complete the transfer. The exchange manager 220 may generate a complete set of transfer conditions with paths for any such exchange participant, using the rates of exchange offered by the exchange participants. The paths may each include an origin sub-transfer at the origin resource tracking system, and a destination sub-transfer at the resource tracking computing device 200.

If the exchange manager 220 determines that it cannot generate a completed set of transfer conditions, it may instead generate partial sets of transfer conditions. The partial sets of transfer conditions may include partial paths, each including a destination sub-transfer at the resource tracking computing device 200 where the source resource pool is controlled by an exchange participant of the hosted exchange at the resource tracking computing device 200, and an incompletely specified linking sub-transfer at another resource tracking system on which that exchange participant controls a resource pool. Partial sets of transfer conditions may be sent by the exchange manager 220 to the appropriate resource tracking systems, which may include their own exchange managers similar to the exchange manager 220. For example, a partial set of transfer conditions may be sent to an additional resource tracking system which includes a resource pool that is the destination resource pool in an incompletely specified linking sub-transfer of the partial set of transfer conditions. When the exchange manager 220 receives a partial set of transfer conditions along with a request for transfer conditions, the exchange manager 220 may attempt to complete the partial set of transfer conditions by completely specifying the linking sub-transfer and adding an origin sub-transfer, based on the exchange participant data from the exchange data 260.

The exchange data 260 may be stored in the storage 240, and may include exchange participant data for any exchange participants of the hosted exchange at the resource tracking computing device 200. The exchange data 260 may be managed by the exchange manager 220, which may store exchange participant data received from exchange manager clients, such as the exchange manager client 110, and may update, change, and remove exchange participant data from the exchange data 260. Exchange participant data from the exchange data 260 may be used by the exchange manager 220 in generating complete and partial sets of transfer conditions.

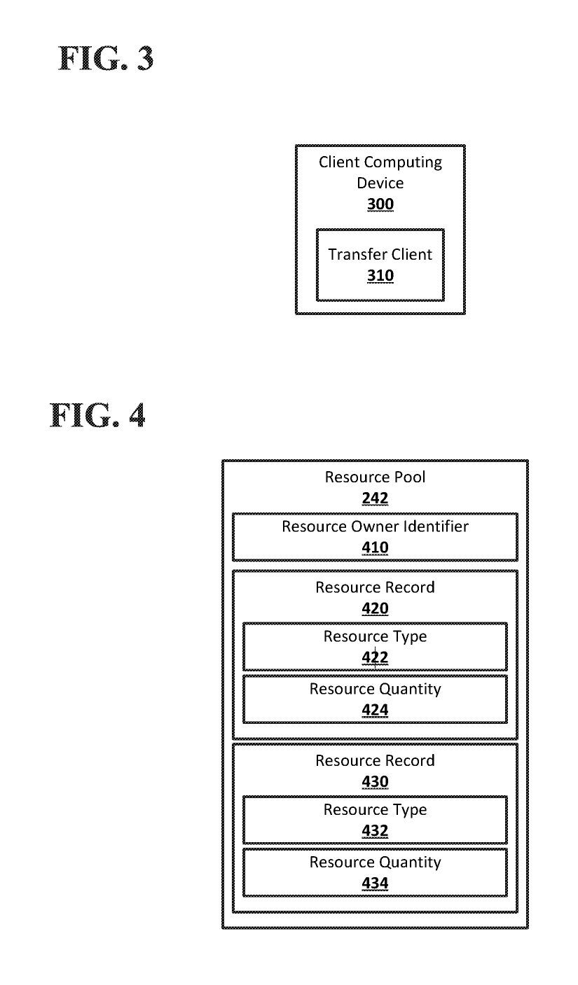

FIG. 3 shows an example system suitable for an exchange hosting server according to an implementation of the disclosed subject matter. A client computing device 300 may include a transfer client 310. The client computing device 300 may be any suitable computing device, such as, for example, a computer 20 as described in FIG. 15, or component thereof, for implementing the transfer client 310. The client computing device 300 may be a single computing device, or may include multiple connected computing devices, and may be, for example, a laptop, a desktop, an individual server, a server farm, or a distributed server system, or may be a virtual computing device or system. The client computing device 300 may be part of a computing system and network infrastructure, or may be otherwise connected to the computing system and network infrastructure. The transfer client 310 may be any suitable combination of hardware and software on the client computing device 300 for sending a request for transfer conditions and selecting and accepting a path from a completed set of transfer conditions. The client computing device 300 may be used by a sending party, which may be any suitable party that may wish to transfer resources to a receiving party, or by a receiving party, which may be any suitable party that may control a destination resource pool for a transfer of resources.

The transfer client 310 may be any suitable combination of hardware and software on the client computing device 300 for sending a request for transfer conditions and selecting and accepting a path from a completed set of transfer conditions. The transfer client 310 may be able to communicate a resource tracking computing system, such as the resource tracking computing device 200. The transfer client 310 may be used, for example, by a sending party, to send a request for transfer conditions to a resource tracking system, such as the resource tracking computing device 200, using any suitable form of communications, such as, for example, HTTP. The transfer client 310 may receive from the resource tracking computing device 200 a completed set of transfer conditions procured by the resource tracking computing device 200 in response to the request for transfer conditions. The transfer client 310 may allow for the selection and acceptance of a path from a completed set of transfer conditions when multiple paths are available, or the acceptance or refusal of a single path if the completed set of transfer conditions includes only one path. The selection and acceptance may be made, for example, through a user interface for the transfer client 310 provided to a user, based on input received from the user, or automatically, for example, through analysis by the transfer client 310 of any paths in completed sets of transfer conditions. The selection of a path may be communicated from the transfer client 310 to the resource tracking computing device 200 using any suitable form of communication, such as, for example, an HTTP POST of the selected path. The transfer client 310 may communicate with the exchange manager client 110 to determine the status of a transfer of resources that is in progress in any suitable manner, such as, for example, through HTTP GET requests. The services implemented by the transfer client 310 may allow, for example, a party such as a person, business, institution, or organization to arrange a transfer of resources. For example, the transfer client 310 may be software run on the client computing device 300, which may be computer, server system, or other suitable computing device controlled by a person business, institution, or organization.

FIG. 4 shows an example system suitable for an exchange hosting server according to an implementation of the disclosed subject matter. The resource pool 242 on the resource tracking computing device 200 may include a resource owner identifier 410, and resource records 420 and 430. The resource owner identifier 410 may be any suitable identification of the party that owns the resources recorded in the resource pool 242. For example, the resource owner identifier may be a name of a person, organization, or user or process on a server system, an arbitrary name, a username and password combination, a passphrase or passcode, a unique number, or a cryptographic public key. The resource records 420 and 430 may include resource types 422 and 432, and resource quantities 424 and 434. The resource types 422 and 432 may indicate the type of resource that is recorded in the resource records 420 and 430. The resource types 422 and 432 may be any suitable resource of asset, such as, for example, currency, cryptocurrency, commodities, financial instruments, or computational resources. The resource quantities 422 and 424 may indicate the quantity of the resource types 422 and 432 owned by the party identified by the resource owner identifier 410 and tracked in the resource pool 242. The resource quantities 422 and 424 may be stored in, for example, registers or memory cells on the resource tracking computing device 200.

The resource tracking computing device 200 may track resources in any suitable manner. For example, the resource tracking computing device 200 may pool resources by type, with each resource pool, such as the resource pool 242, tracking a particular resource type, such as the resource type 422. The resource pool 242 may then include the resource quantity 424 of the resource type 422 held by each party that owns any amount of the resource type 422, using resource owner identifiers such as the resource owner identifier 410.

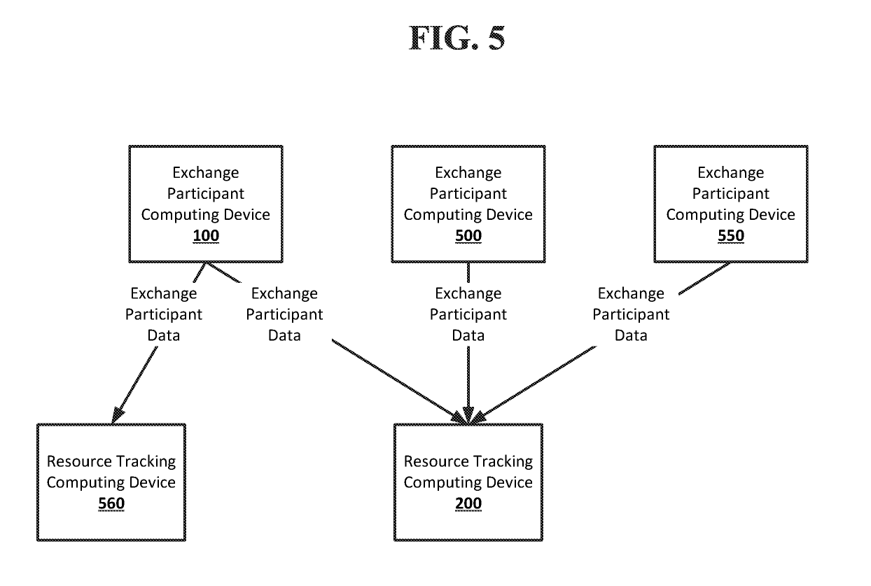

FIG. 5 shows an example arrangement suitable for an exchange hosting server according to an implementation of the disclosed subject matter. The resource tracking computing device 200 may be an exchange hosting server. The hosted exchange on the resource tracking computing device 200 may be managed by the exchange manager 220. Any party that wishes to be a participant in the hosted exchange on the resource tracking computing device 200 may send exchange participant data to the exchange manager 220 of the resource tracking computing device 200. For example, the exchange participant computing device 100, and exchange participant computing devices 500 and 550, may each send exchange participant data to the resource tracking computing device 200. The exchange participant data from the exchange participant computing device 100 may include rates of exchange offered by the exchange participant associated with the exchange participant computing device 100 for effecting a change from other resource types to the resource types tracked in the resource pools, such as the resource pools 242, 244, 252, and 254, of the resource tracking computing device 200. The exchange participant data from the exchange participant computing device 100 may identify the resource pool on the resource tracking computing device 200 controlled by the exchange participant, as well as other resource pools controlled by the exchange participant on other resource tracking systems, including resource tracking systems that are and are not exchange hosting servers, and the resource types they track. For example, the exchange participant associated with the exchange participant computing device 100 may control a resource pool on a resource tracking computing device 560, and may identify this resource pool in the exchange participant data sent to the resource tracking computing device 200.

An exchange participant may be a participant of any number of hosted exchanges. For example, the resource tracking computing device 560 may also be an exchange hosting server. The exchange participant computing device 100 may send exchange participant data to the resource tracking computing device 560, which may include offered rates of exchange from other resource types to resource types tracked by the resource tracking computing device 560, and may identify other resource pools controlled by the exchange participant associated with the exchange participant computing device 100, including the resource pool controlled by the exchange participant on the resource tracking computing device 200. The resource tracking computing device 560 may track any number of resource types, which may be the same as, different from, or overlap with, any resource types tracked by the resource tracking computing device 200.

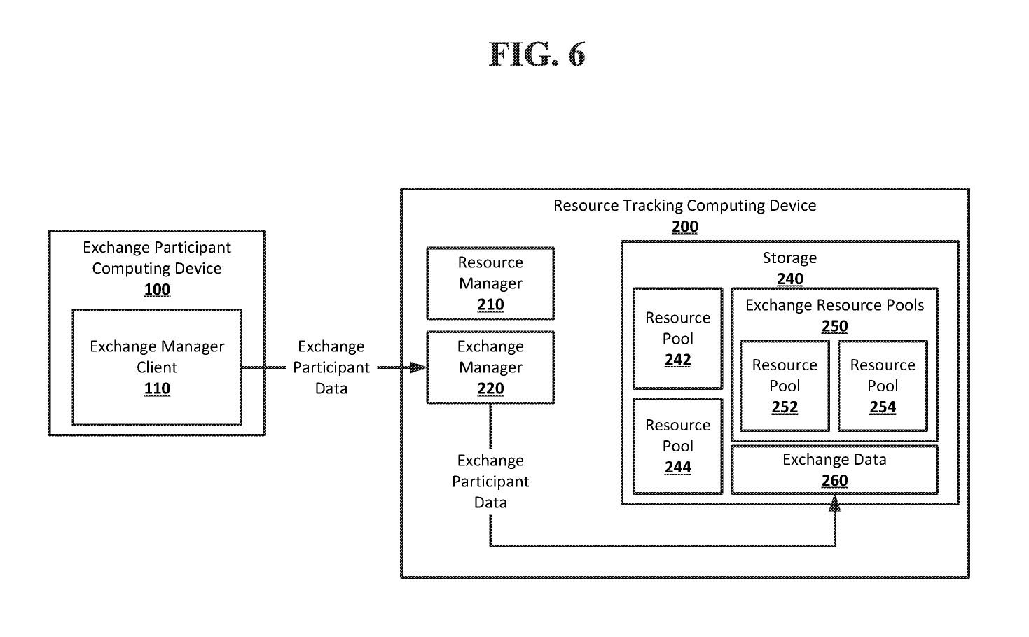

FIG. 6 shows an example arrangement suitable for an exchange hosting server according to an implementation of the disclosed subject matter. The exchange manager client 110 of the exchange participant computing device 100 may send exchange participant data to the exchange manager 220 of the resource tracking computing device 200. The exchange manager 220 may store the exchange participant data as part of the exchange data 260 in the storage 240. The exchange client manager 110 may, at any suitable time, send updates to the previously stored exchange participant data to the exchange manager 220, which may modify the exchange participant data in the exchange data 260 to reflect the updates. The exchange client manager 110 may, at any suitable time, request deletion or inactivation of the previously stored exchange participant data, for example, when the exchange participant associated with the exchange participant computing device 100 wishes to withdraw from the hosted exchange on the resource tracking computing device 200.

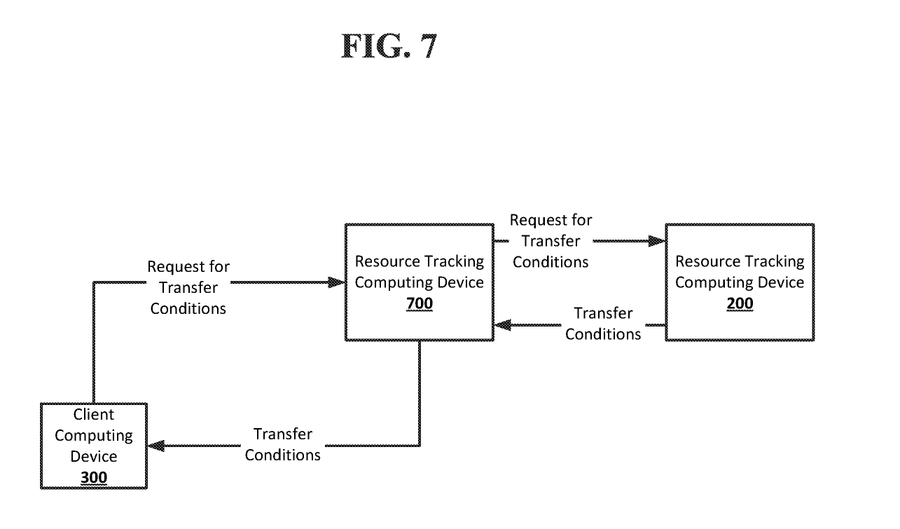

FIG. 7 shows an example arrangement suitable for an exchange hosting server according to an implementation of the disclosed subject matter. The client computing device 300 may send out a request for transfer conditions. For example, the transfer client 310 may gather and compile any suitable data for the request for transfer conditions, and may send the request for transfer conditions to the resource tracking computing device 700 using any suitable communications hardware and protocols. For example, the request for transfer conditions may be sent using an HTTP GET request. The data gathered by the transfer client 310 to be included in the request for transfer conditions may include, for example, an identification of the destination resource pool, an identification of the origin resource pool, and the amount and type of the destination resource to be transferred into the destination resource pool. The resource pools may be identified in any suitable manner, and may further include an identification of the resource tracking system on which the destination resource pool is located.

The request for transfer conditions may be received by resource tracking computing device 700. The resource tracking computing device 700 may be the location of the origin resource pool for the transfer, which may be controlled by a party associated with the client computing device 300. The resource tracking computing device 700 may be an exchange hosting server, but does not need to be an exchange hosting server to be the location of an origin sub-transfer. On receiving the request for transfer conditions, the resource tracking computing device 700 may determine the destination resource tracking system on which the destination resource pool is located, which may be, for example, the resource tracking computing device 200. The request for transfer conditions may include an identification of the destination resource tracking system, or the identity of the destination resource tracking system may be determined based on the identification of the destination resource pool. The request for transfer conditions may be sent from the resource tracking computing device 700, which may be the origin resource transfer system for the transfer, to the resource tracking computing device 200, which may be the destination resource tracking system for the transfer.

The exchange manager 220 of the resource tracking computing device 200 may analyze the received request for transfer conditions and may determine, for example, that no additional resource tracking system are needed for the transfer of resources. For example, the exchange manager 220 may determine from the exchange participant data in the exchange data 260 that there is at least one exchange participant of the exchange hosted at the resource tracking computing device 200 that controls a resource pool at the resource tracking computing device 700 and has a large enough quantity of resources in a resource pool at the resource tracking computing device 200 to complete the transfer. For each such exchange participant, the exchange manger 220 may complete the set of transfer conditions with a path that includes an origin sub-transfer from the origin resource pool on the resource tracking computing device 700 to a resource pool on the resource tracking computing device 700 controlled by the exchange participant, and a destination sub-transfer from a resource pool on the resource tracking computing device 200 controlled by the exchange participant to the destination resource pool on the resource tracking computing device 700. The origin sub-transfer may transfer the origin resource, and the destination sub-transfer may transfer the destination resource, as specified in the request for transfer conditions. A path in the completed set of transfer conditions may include an indication of the rate of exchange offered by an exchange participant for effecting a change from the origin resource to the destination resource, as well as any fees that may be imposed by the exchange participant or by the resource tracking computing devices 200 and 700. This may allow for each path to be evaluated based on its total cost to the sending party as a quantity of the origin resource that will be transferred out by the sending party. The completed set of transfer conditions may be sent back to the resource tracking computing device 700, which may then send them to the client computing device 300 for selection of a path.

For example, the resource tracking computing device 700 may belong to a branch of a US bank, and the origin resource pool may be an account at the US bank branch. The destination resource pool may be an account located on the resource tracking computing device 200, which may belong to a branch of a European bank. The origin resource may be US dollars, and the destination resource may be Euros. A request for transfer conditions may be sent from the client computing device 300 to the resource tracking computing device 700 at the US bank branch. The client computing device 300 may be associated with a sending party that controls the account at the US bank branch. The request for transfer conditions may specify that the destination resource pool, the account at the European bank branch, is to receive 1000 Euros. The resource tracking computing device 700 at the US bank branch may identify the resource tracking computing device 200 of the European bank branch as the destination resource tracking system and location of the destination resource pool.

The resource tracking computing device 700 may send the request for transfer conditions to the resource tracking computing device 200. The exchange manager 220 of the resource tracking computing device 200 may identify exchange participants that both have an account at the US bank branch, as tracked by the on the resource tracking computing device 700, and have enough Euros in an account at the European bank branch, on the resource tracking computing device 200, to make the destination transfer of 1000 Euros in the account that is the destination resource pool. Such identified exchange participants may have paths in the completed set of transfer conditions generated at the European bank branch by the resource tracking computing device 200. A path may include an origin sub-transfer on the resource tracking computing device 700 of the US bank branch of US dollars from the account that is the origin resource pool to an account controlled by an exchange participant of the hosted exchange at the resource tracking computing device 200 of the European bank branch, and a destination sub-transfer of 1000 Euros from the account controlled by the exchange participant to the account that is the destination resource pool on the resource tracking computing device 200 at the European bank branch. The quantity of US dollars needed in the origin sub-transfer for a path may be based on the rate of exchange offered by the exchange participant for the path. For example, if the exchange participant offers a rate of 1 Euro for 1.20 US dollars, and there are no fees, the origin sub-transfer may transfer 1200 US dollars at the US bank branch from the account of the sending party to the account of the exchange participant of the European bank branch. The destination sub-transfer may transfer 1000 Euros at the European bank branch from the account of the exchange participant to the account of the receiving party. The completed set of transfer conditions may be sent from the resource tracking computing device 200 at the European bank branch back to the resource tracking computing device 700 at the US bank branch, which may in turn send them to the client computing device 300 for selection of a path.

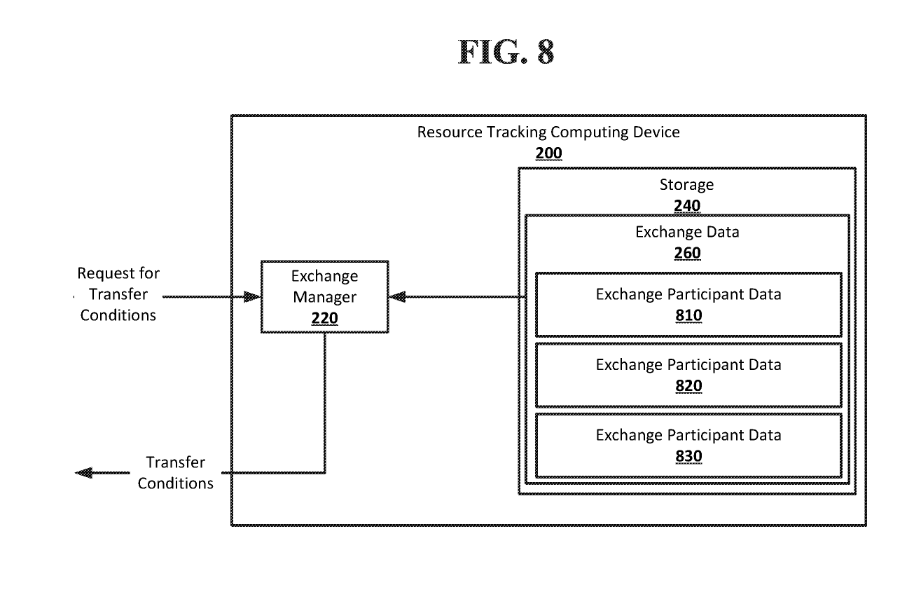

FIG. 8 shows an example arrangement suitable for an exchange hosting server according to an implementation of the disclosed subject matter. When a request for transfer conditions is received at the resource tracking computing device 200, the exchange manager 220 may attempt to generate a complete set of transfer conditions with paths that can be used to execute the transfer specified in the request for transfer conditions. The exchange manager 220 may determine if there is an exchange participant on the hosted exchange at the resource tracking computing device 200 that can complete the transfer by examining the exchange participant data in the exchange data 260. For example, if there are three exchange participants of the hosted exchange at the resource tracking computing device 200, the exchange data 260 may include three separate sets of exchange participant data, for example, exchange participant data 810, 820, and 830. Each of the sets of the exchange participant data 810, 820, and 830 may have been received from an exchange manager client, such as the exchange manager client 110, of an exchange participant computing device, such as the exchange participant computing device 100. Each of the sets of the exchange participant data 810, 820, and 830 may include rates of exchange offered by exchange participants, and the location of other resource pools controlled by exchange participants. Because exchange participant data, such as the exchange participant data 810, 820, and 830, is stored only on the resource tracking systems it is sent to, such as the resource tracking computing device 200, an exchange participant may control which hosted exchanges it is a participant in, which resource types it will effect changes between, and in which directions it will effect those changes, for example, effecting a change from a first resource type to a second resource type, but not from the second resource type to the first resource type.

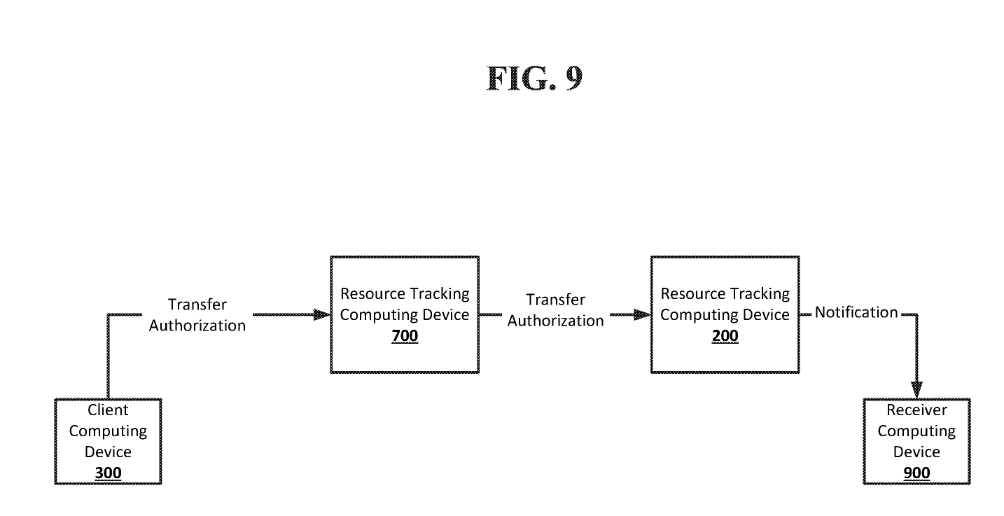

FIG. 9 shows an example arrangement suitable for an exchange hosting server according to an implementation of the disclosed subject matter. The client computing device 300 may receive the completed set of transfer conditions from the resource tracking computing device 700. The transfer client 310 may be used to evaluate the set of transfer conditions and select a path, for example, based on human or automated evaluation and selection. The selected path may be, for example, the path which requires the smallest quantity of the origin resource to be transferred out of the origin resource pool. The transfer client 310 may send out, from the client computing device 300, a transfer authorization to the resource tracking computing device 700. The transfer authorization may include an indication of the path selected at the client computing device 300.

The resource tracking computing device 700 may include the origin resource pool for the transfer of resources, and a sink resource pool for the origin sub-transfer. The sink resource pool may be specified in the path selected at the client computing device 300, and may be controlled by an exchange participant of the hosted exchange at the resource tracking computing device 200. The resource tracking computing device 700 may execute the origin sub-transfer by transferring a specified quantity of the origin resource from the origin resource pool to the sink resource pool for the origin sub-transfer. The resource tracking computing device 700 may confirm the successful execution of the transfer to the client computing device 300, for example, by sending a confirmation to the client computing device 300.

The resource tracking computing device 200 may include the destination resource pool for the transfer of resources and a source resource pool for the destination sub-transfer. The source resource pool may be specified in the path selected at the client computing device 300, and may be controlled by an exchange participant of the hosted exchange at the resource tracking computing device 200. The resource tracking computing device 200 may receive the transfer authorization from the resource tracking computing device 700, for example, before, after, or during the execution of the origin sub-transfer. The resource tracking computing device 200 may execute the destination sub-transfer by transferring a specified quantity of the destination resource. The resource tracking computing device 200 may confirm the successful execution of the transfer to the client computing device 300, for example, by sending a confirmation to the client computing device 300. A receiving party for the transfer, which may control the destination resource pool on the resource tracking computing device 200, may receive a notification when the transfer of resource has been completed, for example, at a receiver computing device 900.

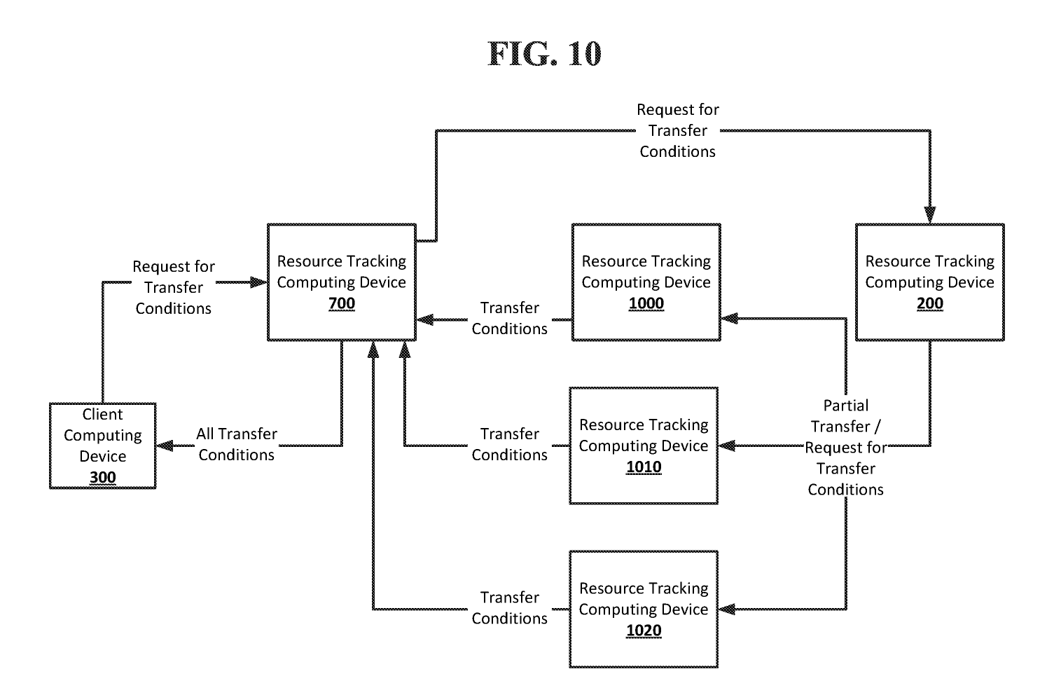

FIG. 10 shows an example arrangement suitable for an exchange hosting server according to an implementation of the disclosed subject matter. The client computing device 300 may send out a request for transfer conditions. For example, the transfer client 310 may gather and compile any suitable data for the request for transfer conditions, and may send the request for transfer conditions to the resource tracking computing device 700 using any suitable communications hardware and protocols. For example, the request for transfer conditions may be sent using an HTTP GET request. The data gathered by the transfer client 310 to be included in the request for transfer conditions may include, for example, an identification of the destination resource pool, an identification of the origin resource pool, and the amount and type of the destination resource to be transferred into the destination resource pool. The resource pools may be identified in any suitable manner, and may further include an identification of the resource tracking system on which the destination resource pool is located.

The request for transfer conditions may be received by resource tracking computing device 700. The resource tracking computing device 700 may be the location of the origin resource pool for the transfer, which may be controlled by a party associated with the client computing device 300. The resource tracking computing device 700 may be an exchange hosting server, but does not need to be an exchange hosting server to be the location of an origin sub-transfer. On receiving the request for transfer conditions, the resource tracking computing device 700 may determine the destination resource tracking system on which the destination resource pool is located, which may be, for example, the resource tracking computing device 200. The request for transfer conditions may include an identification of the destination resource tracking system, or the identity of the destination resource tracking system may be determined based on the identification of the destination resource pool. The request for transfer conditions may be sent from the resource tracking computing device 700, which may be the origin resource transfer system for the transfer, to the resource tracking computing device 200, which may be the destination resource tracking system for the transfer.

The exchange manager 220 of the resource tracking computing device 200 may analyze the received request for transfer conditions and may determine that an additional resource tracking system may be needed for the transfer of resources. For example, the exchange manager 220 may determine from the exchange participant data in the exchange data 260 that there are no exchange participants of the resource tracking computing device 200 that control a resource pool at the resource tracking computing device 700 and have a large enough quantity of resources in a resource pool at the resource tracking computing device 200 to complete the transfer. The exchange manager 220 may generate a partial set of transfer conditions.

To generate the partial set of transfer conditions, the exchange manager 220 may identify exchange participants that control a resource pool at the resource tracking computing device 200 with a large enough quantity of resources to complete the transfer. For each such exchange participant, the exchange manger 220 may generate, for the partial set of transfer conditions, an incomplete path that includes a destination sub-transfer from a resource pool on the resource tracking computing device 200 controlled by the exchange participant to the destination resource pool on the resource tracking computing device 700, and an incompletely specified linking sub-transfer which may use a resource pool controlled by the exchange participant on another resource tracking system, such as a resource tracking computing device 1000, as a sink resource pool, but may not specify a source resource pool. The destination sub-transfer may transfer the destination resource, as specified in the request for transfer conditions. The incompletely specified linking sub-transfer may transfer any resource that is tracked by the resource tracking computing device 1000, which be the same as either the origin resource or destination resource for the transfer, or different from both. An incomplete path in the partial set of transfer conditions may include an indication of the rate of exchange offered by an exchange participant for effecting a change from any resource types on another resource tracking system, such as the resource tracking computing device 1000, to the destination resource, as well as any fees that may be imposed by the exchange participant or by the resource tracking computing devices 200 and 1000. Different exchange participants may control resource pools on different other resource tracking systems.

A separate partial set of transfer conditions may be generated for each distinct resource tracking system on which a sink resource pool for a linking sub-transfer is located, with each partial set of transfer conditions including paths that only use a specific one of the other resource tracking systems. Alternatively, all paths may be included in a single partial set of transfer conditions which may be divided when being sent out by the resource tracking computing device 200 so that each of the other resource tracking system receives only the paths that include it. For example, the exchange manager 220 may identify three exchange participants on the resource tracking computing device 200 that control resource pools on the resource tracking computing device 200 with a large enough quantity of resources to complete the transfer. The first exchange participant may also control a resource pool on the resource tracking computing device 1000, the second exchange participant may also control resource pools on a resource tracking computing devices 1010 and the resource tracking computing device 1000, and the third exchange participant may also control resource pools on a resource tracking computing device 1020 and the resource tracking computing device 1010. The exchange manager 220 may generate five incomplete paths, one for each resource pool controlled on one of the other resource tracking systems by an exchange participant that can complete the transfer. The first path may include a linking sub-transfer with a sink resource pool controlled by the first exchange participant on the resource tracking computing device 1000. The second path may include a linking sub-transfer with a sink resource pool controlled by the second exchange participant on the resource tracking computing device 1000. The third path may include a linking sub-transfer with a sink resource pool controlled by the second exchange participant on the resource tracking computing device 1010. The fourth path may include a linking sub-transfer with a sink resource pool controlled by the third exchange participant on the resource tracking computing device 1010. The fifth path may include a linking sub-transfer with a sink resource pool controlled by the second exchange participant on the resource tracking computing device 1020. The first and second paths may be included in a partial set of transfer conditions sent to the resource tracking computing device 1000. The third and fourth paths may be included in a partial set of transfer conditions sent to the resource tracking computing device 1010. The fifth path may be included in a partial set of transfer conditions sent to the resource tracking computing device 1020.

The resource tracking computing devices 1000, 1010, and 1020 may receive partial sets of transfer conditions and the request for transfer conditions, and may attempt generate complete sets of transfer conditions as specified in the request for transfer conditions. For example, the exchange manager of the resource tracking computing device 1000 may analyze the received partial set of transfer conditions and request for transfer conditions and may determine, for example, that no other additional resource tracking system are needed for the transfer of resources. For example, the exchange manager of the resource tracking computing device 1000 may determine from stored exchange participant data that there is at least one exchange participant of the exchange hosted at the resource tracking computing device 1000 that controls a resource pool at the resource tracking computing device 700 and has a large enough quantity of resources in a resource pool at the resource tracking computing device 1000 to complete the linking sub-transfer. For each such exchange participant, the exchange manager of the resource tracking computing device 1000 may complete the partial set of transfer conditions by adding completed paths that include an origin sub-transfer from the origin resource pool on the resource tracking computing device 700 to a resource pool on the resource tracking computing device 700 controlled by the exchange participant of the resource tracking computing device 1000, and completing the incompletely specified linking sub-transfer by adding a resource pool on the resource tracking computing device 1000 controlled by the exchange participant as the source resource pool. The origin sub-transfer may transfer the origin resource, and the linking sub-transfer may transfer any resource tracked by the resource tracking computing device 1000. The origin sub-transfer and linking sub-transfer may be combined with the destination sub-transfer that was part of the incomplete path with the incompletely specified linking sub-transfer in the partial set of transfer conditions to generate a complete path. A path in the completed set of transfer conditions may include an indication of the rate of exchange offered by an exchange participant for effecting a change from the origin resource to the resource transferred on the resource tracking computing device 1000, the rate of exchange offered by an exchange participant for effecting a change from the resource transferred on the resource tracking computing device 1000 to the destination resource, and any fees that may be imposed by the exchange participant or by the resource tracking computing devices 200, 700, and 1000. This may allow for each path to be evaluated based on its total cost to the sending party as a quantity of the origin resource that will be transferred out by the sending party. The resource tracking computing devices 1010 and 1020 may similarly generate completed sets of transfer conditions based on their stored exchange participant data. The completed set of transfer conditions may be sent back to the resource tracking computing device 700, which may then send them to the client computing device 300 for selection of a path.

For example, the resource tracking computing device 700 may belong to a branch of a US bank, and the origin resource pool may be an account at the US bank branch. The destination resource pool may be an account located on the resource tracking computing device 200, which may belong to a branch of a European bank. The origin resource may be US dollars, and the destination resource may be Euros. A request for transfer conditions may be sent from the client computing device 300 to the resource tracking computing device 700 at the US bank branch. The client computing device 300 may be associated with a sending party that controls the account at the US bank branch. The request for transfer conditions may specify that the destination resource pool, the account at the European bank branch, is to receive 1000 Euros. The resource tracking computing device 700 at the US bank branch may identify the resource tracking computing device 200 at the European bank branch as the destination resource tracking system and location of the destination resource pool.

The resource tracking computing device 700 may send the request for transfer conditions to the resource tracking computing device 200. The exchange manager 220 of the resource tracking computing device 200 may attempt to identify exchange participants that both have an account at the US bank branch, as tracked by the on the resource tracking computing device 700, and have enough Euros in an account at the European bank branch, on the resource tracking computing device 200, to make the destination transfer of 1000 Euros to the account that is the destination resource pool. There may be no such exchange participants at the European bank branch, as determined based on the exchange data 260 stored on the resource tracking computing device 200. The exchange manger 220 may generate a partial set of transfer conditions based on exchange participants at the European bank branch which have enough Euros at the European bank branch to make the destination sub-transfer. The partial set of transfer conditions generated by the exchange manager 220 may include incomplete paths with the destination sub-transfer for each such exchange participant and incompletely specified linking sub-transfers with sink resource pools that are accounts controlled by the exchange participants on other resource tracking systems.

The paths in the partial set of transfer conditions may be divided up based on the resource tracking system on which the accounts that are the sink resource pools in the incompletely specified linking sub-transfer of the paths are located, so that the partial set of transfer conditions sent to a particular resource tracking system only includes paths with sink resource pools on that resource tracking system. For example, a first and second exchange participant at the European bank branch may control accounts with at least 1000 Euros at the European bank branch, and may control accounts at the resource tracking computing device 1000, which may belong to a ledger for a cryptocurrency. The second exchange participant may also control an account at the resource tracking computing device 1010, which may belong to a branch of a second US bank. A third exchange participant may control an account with at least 1000 Euros at the European bank branch and an account at the resource tracking computing device 1020, which may belong to a branch of a UK bank. The partial set of transfer conditions sent to the resource tracking computing device 1000 of the cryptocurrency ledger may include two paths, and the two linking sub-transfers may include sink resource pools which are the account controlled by the first exchange participant on the cryptocurrency ledger and the account controlled by the second exchange participant on the cryptocurrency ledger. The rate of exchange for the paths may be for a change from the cryptocurrency to Euros. The partial set of transfer conditions sent to the resource tracking computing device 1010 of the branch of the second US bank may include one path, with a linking sub-transfer where the sink resource pool is the account controlled by the second exchange participant at the branch of the second US bank. The rate of exchange for the path may be for a change from the US dollars to Euros. The partial set of transfer conditions sent to the resource tracking computing device 1020 of the branch of the UK bank may include one path, with a linking sub-transfer where the sink resource pool is the account controlled by the third exchange participant at the branch of the UK bank. The rate of exchange for the path may be for a change from the UK pounds to Euros.

The resource tracking systems 1000, 1010, and 1020 may attempt to complete their received partial set of transfer conditions. For example, an exchange manager of the cryptocurrency ledger may determine if there are any exchange participants at the cryptocurrency ledger with a large enough quantity of cryptocurrency to complete the linking sub-transfer and which also control an account on the resource tracking system 700 at the branch of the US bank. For each such exchange participant, the exchange manager of the cryptocurrency ledger may generate completed paths by generating an origin sub-transfer from the origin resource pool, the account of the sending party at the branch of the US bank, to an account at the US bank controlled by the exchange participant of the cryptocurrency ledger, and completing each of the incompletely specified linking sub-transfers by specifying the account of the exchange participant of the cryptocurrency ledger as the source resource pool. For example, the partial set of transfer conditions may have included two incomplete paths. The exchange manager of the cryptocurrency ledger may identify two exchange participants that can complete the transfer. The exchange manger may generate four complete paths. Each of the four paths may include one of two origin sub-transfers, one for each exchange participant identified by the cryptocurrency ledger, one of four linking sub-transfers between accounts controlled on the cryptocurrency ledger by the two exchange participants of the cryptocurrency ledger and two exchange participants at the branch of the European bank, and one of the two destination sub-transfers from the account at the branch of the European bank controlled by the exchange participants at the branch of the European bank to the destination resource pool. The exchange participant of the branch of the European bank in the destination sub-transfer of a path may be the same as the exchange participant of the branch of the European bank in the linking sub-transfer for that path. The paths may include rates of exchange that are from US dollars to the cryptocurrency, as offered by an exchange participant of the cryptocurrency ledger, and from the cryptocurrency to Euros, as offered by the exchange participant of the branch of the European bank. The branch of the second US bank, and the branch of the UK bank, may similarly attempt generate completed sets of transfer conditions with complete paths. At the second US bank, the paths may only include a rate of exchange from US dollars to Euros, as the exchange participant at the branch of the second US bank may be both receiving and transferring US dollars, and may therefore not be effecting a change in resource type. The exchange participant at the branch of the second US bank may still impose fees. The completed set of transfer conditions may be sent from the resource tracking computing devices 1000, 1010, and 1020 back to the resource tracking computing device 700 at the branch of the US bank which may in turn send them to the client computing device 300 for selection of a path. The quantity of resources a path requires the sending party to transfer out of the origin resource account may be based on all of the rates of exchange included in the path, and the sending party may select, for example, the path with lowest total cost in terms of the origin resource.

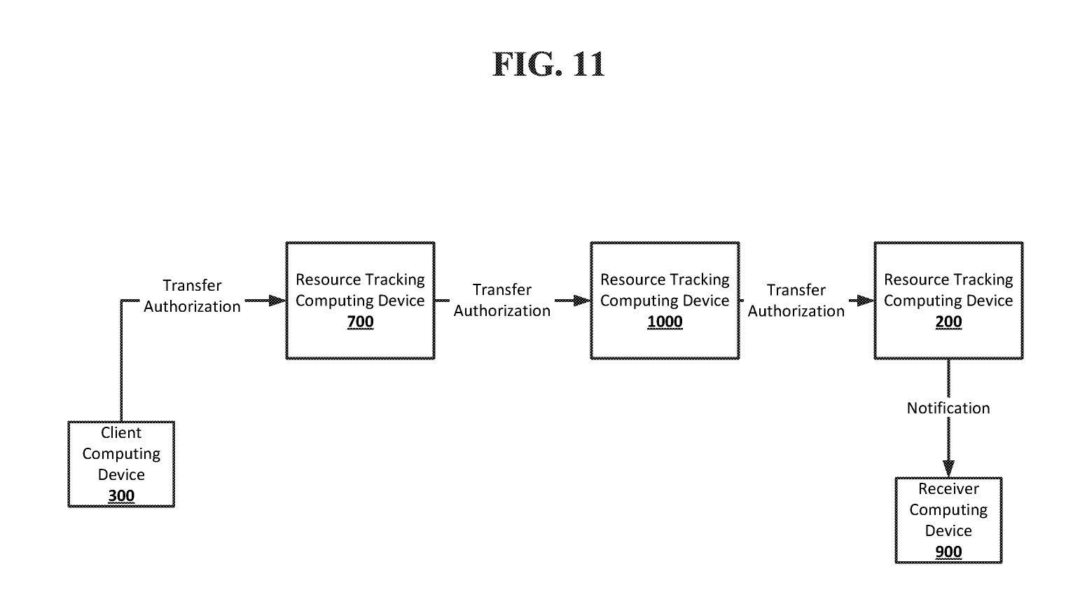

FIG. 11 shows an example arrangement suitable for an exchange hosting server according to an implementation of the disclosed subject matter. The client computing device 300 may receive the completed set of transfer conditions from the resource tracking computing device 700. The transfer client 310 may be used to evaluate the set of transfer conditions and select a path, for example, based on human or automated evaluation and selection. The selected path may be, for example, the path which requires the smallest quantity of the origin resource to be transferred out of the origin resource pool. The transfer client 310 may send out, from the client computing device 300, a transfer authorization to the resource tracking computing device 700. The transfer authorization may include an indication of the path selected at the client computing device 300.

The resource tracking computing device 700 may include the origin resource pool for the transfer of resources, and a sink resource pool for the origin sub-transfer. The sink resource pool may be specified in the path selected at the client computing device 300, and may be controlled by an exchange participant of the hosted exchange at the resource tracking computing device 1000, which may be the location of the source and sink resource pools for the linking sub-transfer in the path. The resource tracking computing device 700 may execute the origin sub-transfer by transferring a specified quantity of the origin resource from the origin resource pool to the sink resource pool for the origin sub-transfer. The resource tracking computing device 700 may confirm the successful execution of the transfer to the client computing device 300, for example, by sending a confirmation to the client computing device 300.

The resource tracking computing device 1000 may include the source and sink resource pools for the linking sub-transfer in the path chosen at the client computing device 300. The source resource pool may be specified in the path selected at the client computing device 300, and may be controlled by an exchange participant of the hosted exchange at the resource tracking computing device 1000. The sink resource pool may be specified in the path selected at the client computing device 300, and may be controlled by an exchange participant of the hosted exchange at the resource tracking computing device 200. The resource tracking computing device 1000 may receive the transfer authorization from the resource tracking computing device 700, for example, before, after, or during the execution of the origin sub-transfer. The resource tracking computing device 1000 may execute the linking sub-transfer by transferring a specified quantity of a resource tracked in the source and sink resource pools of the linking sub-transfer. The resource tracking computing device 1000 may confirm the successful execution of the linking sub-transfer to the client computing device 300, for example, by sending a confirmation to the client computing device 300

The resource tracking computing device 200 may include the destination resource pool for the transfer of resources and a source resource pool for the destination sub-transfer. The source resource pool may be specified in the path selected at the client computing device 300, and may be controlled by an exchange participant of the hosted exchange at the resource tracking computing device 200. The resource tracking computing device 200 may receive the transfer authorization from the resource tracking computing device 700, for example, before, after, or during the execution of the origin sub-transfer and linking sub-transfer. The resource tracking computing device 200 may execute the destination sub-transfer by transferring a specified quantity of the destination resource. The resource tracking computing device 200 may confirm the successful execution of the transfer to the client computing device 300, for example, by sending a confirmation to the client computing device 300. A receiving party for the transfer, which may control the destination resource pool on the resource tracking computing device 200, may receive a notification when the transfer of resource has been completed, for example, at a receiver computing device 900.

The exchange manager 220 may also identify multiple exchange participants that control resource pools at the resource tracking computing device 200 and do not individually have a large enough quantity of resources to complete the transfer, but have a large enough quantity of resources to complete the transfer in combination with each other. For example, there may be a first exchange participant that controls a resource pool on the resource tracking computing device 200 with enough resources to complete half of the transfer, while a second exchange participant controls a resource pool on the resource tracking computing device 200 with enough resources for the other half of the transfer, though not enough to complete the whole transfer itself.

For each such combination of exchange participants, the exchange manger 220 may generate a set of linked paths. The paths in a set of linked paths may be any combination of complete paths generated by the exchange manager 220 and paths that are generated as incomplete paths by the exchange manager 220 and are completed using additional resource tracking computing devices. For example, a set of linked paths may include a first path and a second path which may both be complete paths when the exchange participants for the first linked path and the second linked path both control resource pools on the resource tracking computing device 200 and the resource tracking computing device 700. The set of transfer conditions sent to the client computing device 300 from the resource tracking computing device 200 through the resource tracking computing device 700 may include the complete linked paths. The linking of the paths may indicate to the client computing device 300 that the requested transfer can be completed by selecting the set of linked paths, but not by selecting either of the paths in the set of linked paths individually. The client computing device 300 may be unable to select individual paths that are part of the set of linked paths, as this may not complete the transfer. Any number of paths may be linked in a set of linked paths, and any number of sets of linked paths may be sent to the client computing device.

A set of linked paths may include any combination of paths that need no extra resource tracking computing devices and those that need extra resource tracking computing devices. The exchange manager 220 may, for example, generate a set of linked paths where some of the paths are complete, and some are incomplete and require an additional resource tracking computing device to be completed. For example, a first path in a set of linked paths may be for a first exchange participant that controls resource pools on both the resource tracking computing device 200 and the resource tracking computing device 700. This first path may be able to transfer some portion, for example, half of the resources needed to complete the transfer as specified in the requests for transfer conditions from the client computing device 300. A second path in the set of linked paths may be for a second exchange participant that controls a resource pool on the resource tracking computing device 200, but does not control a resource pool on the resource tracking computing device 700. The exchange manager 220 may generate an incomplete path for the second exchange participant, which may be sent as part of a set of partial transfer conditions to other resource tracking computing devices on which the second exchange participant controls a resource pool, such as for example, any of the resource tracking computing devices 1000, 1010, and 1020. The exchange manager of a resource tracking computing device that receives the partial set of transfer conditions may attempt to complete the path for the second exchange participant, but may only need to do so for the portion of the resources from the original request for transfer conditions that are being transferred by the second exchange participant, rather than for all of the resources that were in the original request for transfer conditions. When one of the additional resource tracking computing devices completes the incomplete path for the second exchange participant, the completed set of transfer conditions, including the completed path for the second exchange participant, may be sent to the resource tracking computing device 700 and passed to the client computing device 300. The paths for the first and second exchange participants may be rejoined as the set of linked paths at either the resource tracking computing device 700 or the client computing device 300, so that the client computing device 300 may only select the set of linked paths in combination, and may not select the constituent paths of the set of linked not separately from each other. When a set of linked paths is selected by the client computing device 300, the transfer authorization may authorize all of the paths in the set of linked paths. Transfers across each path may occur sequentially, simultaneously, or with any other suitable relative timing. If a transfer across one of the paths from a set of linked paths fails, the entire transfer may fail, and any transfers made using any other paths in the set of linked paths may be rolled back.

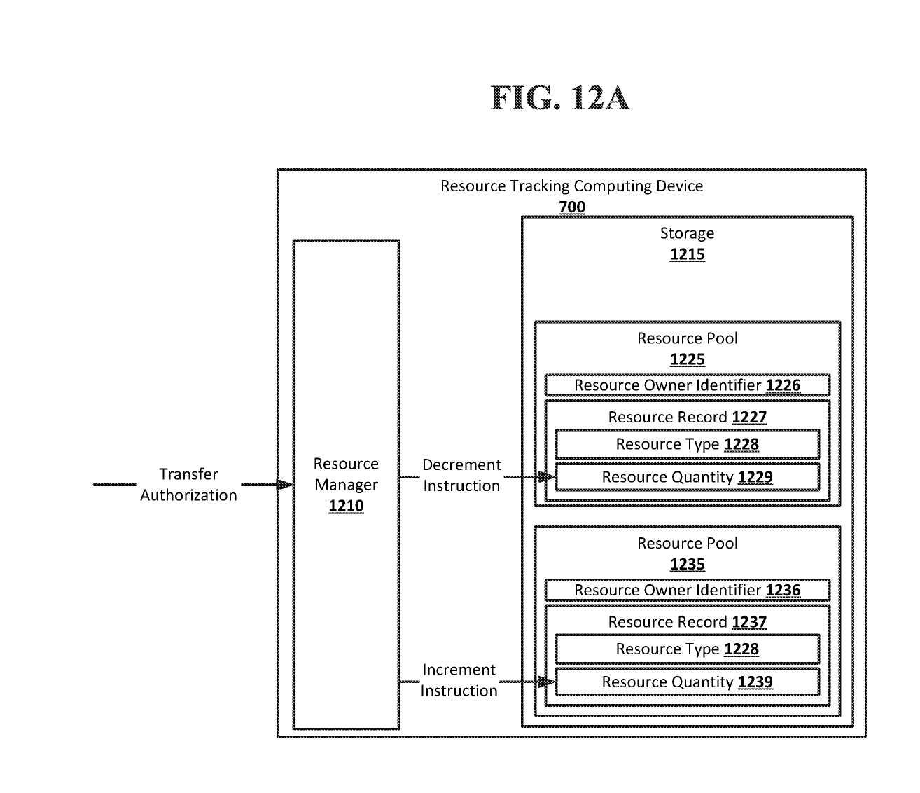

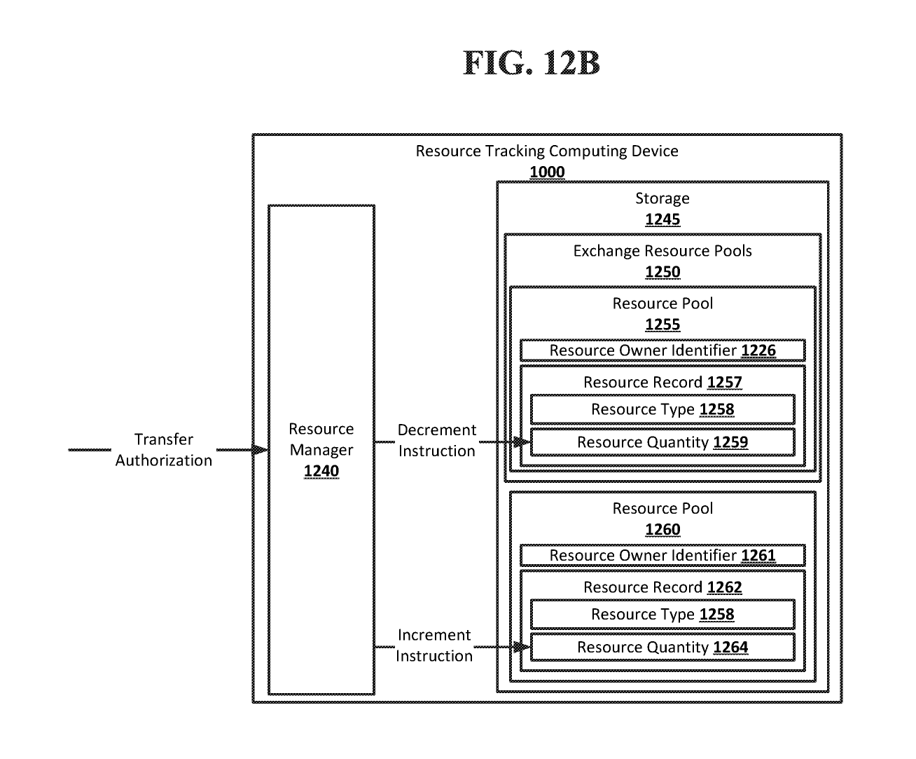

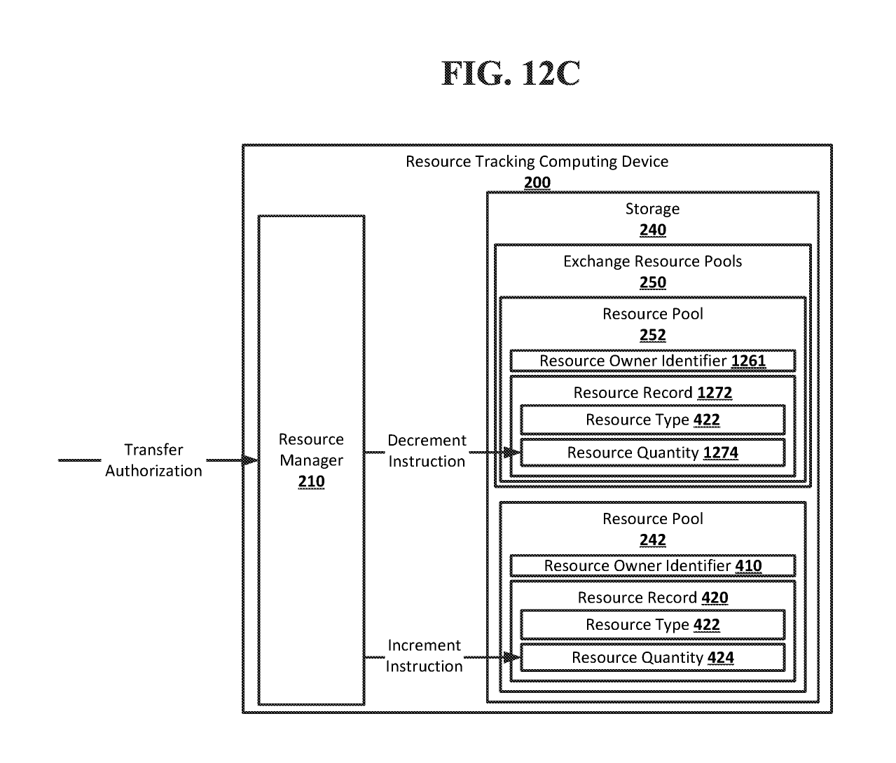

FIG. 12A shows an example arrangement suitable for an exchange hosting server according to an implementation of the disclosed subject matter. The client computing device 300 may send a transfer authorization, including an indication of a path and transfer instructions resource tracking computing device 700. The resource tracking computing device 700 may effect the origin sub-transfer in the path, transferring resources from a resource pool 1225 to a resource pool 1235. A resource manager 1210 may decrement a resource quantity 1229, in the resource pool 1225, by a quantity specified in the origin sub-transfer, and increment a resource quantity 1239, in the resource pool 1235, by that same quantity. The resource may be of resource type 1228, which may be the same for both resource pool 1225 and 1235. This may result in the resource pool 1235 recording that the party identified by resource owner identifier 1236, which may be, for example, an exchange participant of the resource tracking computing device 1000, controls an increased quantity of the resource type 1228, as specified in resource record 1237. The resource pool 1225 may record that the party identified by the resource owner identifier 1226, for example, the sending party associated with the client computing device 300, controls a decreased quantity of the resource type 1228, as specified in resource record 1227. The total quantity of the resource type 1228 tracked by the resource tracking computing device 700 may not have changed, only the quantities of the resource as recorded by resource records 1227 and 1237 for the resource pools 1225 and 1235 may have changed. The resource pool 1225 may be the origin resource pool for the transfer, and the resource pool 1235 may be the sink resource pool for the origin sub-transfer. Both the resource pool 1225 and 1235 may be stored in storage 1215 on the resource tracking computing device 700.

The resource quantities 1229 and 1239 may be counters stored in registers or memory cells. When the resource quantity 1229 is decremented, the quantity recorded by the counter may be decreased by the quantity specified in the origin sub-transfer. The resource quantities 1229 and 1239 may also include locations or other identifiers for specific resources, such as those with physical instantiations such as commodities or block of memory, or financial instruments or other resources that may be individually distinguishable. This may allow the transfer of specific resources, such as specific commodities stored at specific locations, specific shares of stock, specific bonds, specific contracts such as, for example options contracts, and so on.

FIG. 12B shows an example arrangement suitable for an exchange hosting server according to an implementation of the disclosed subject matter. The transfer authorization, including an indication of a path and transfer instructions, may be sent to the resource tracking computing device 1000, for example, by the resource tracking computing device 700. The resource tracking computing device 1000 may effect the linking sub-transfer in the path, transferring resources from a resource pool 1255 to a resource pool 1260. A resource manager 1240 may decrement a resource quantity 1259, in the resource pool 1255, by a quantity specified in the linking sub-transfer, and increment a resource quantity 1264, in the resource pool 1260, by that same quantity. The resource may be of resource type 1258, which may be the same for both resource pool 1255 and 1260. This may result in the resource pool 1260 recording that the party identified by resource owner identifier 1261, which may be, for example, an exchange participant of the resource tracking computing device 200, controls an increased quantity of the resource type 1258, as specified in resource record 1262. The resource pool 1255 may record that the party identified by the resource owner identifier 1226, for example, the exchange participant of the resource tracking computing device 1000, controls a decreased quantity of the resource type 1258, as specified in resource record 1257. The total quantity of the resource type 1258 tracked by the resource tracking computing device 1000 may not have changed, only the quantities of the resource as recorded by resource records 1257 and 1262 for the resource pools 1255 and 1260 may have changed. The resource pool 1255 may be the source resource pool for the linking sub-transfer, may be controlled by the exchange participant that also controls the resource pool 1225 on the resource tracking computing device 700, and may be stored as part of exchange resource pools 1250 in the storage 1245 of the resource tracking computing device 1000. The resource pool 1235 may be the sink resource pool for the origin sub-transfer.

The resource quantities 1259 and 1264 may be counters stored in registers or memory cells. When the resource quantity 1259 is decremented, the quantity recorded by the counter may be decreased by the quantity specified in the linking sub-transfer. The resource quantities 1259 and 1264 may also include locations or other identifiers for specific resources, such as those with physical instantiations such as commodities or block of memory, or financial instruments or other resources that may be individually distinguishable. This may allow the transfer of specific resources, such as specific commodities stored at specific locations, specific shares of stock, specific bonds, specific contracts such as, for example options contracts, and so on.

FIG. 12C shows an example arrangement suitable for an exchange hosting server according to an implementation of the disclosed subject matter. The transfer authorization, including an indication of a path and transfer instructions, may be sent to the resource tracking computing device 200, for example, by the resource tracking computing device 1000. The resource tracking computing device 700 may effect the destination sub-transfer in the path, transferring resources from the resource pool 252 to the resource pool 242. The resource manager 210 may decrement a resource quantity 1274, in the resource pool 252, by a quantity specified in the destination sub-transfer, and increment a resource quantity 424, in the resource pool 242, by that same quantity. The resource may be of resource type 422, which may be the same for both resource pool 242 and 252. This may result in the resource pool 252 recording that the party identified by resource owner identifier 410, which may be, for example, the receiving party for the transfer, controls an increased quantity of the resource type 422, as specified in resource record 420. The resource pool 252 may record that the party identified by the resource owner identifier 1261, for example, the exchange participant of the resource tracking computing device 200, controls a decreased quantity of the resource type 422, as specified in resource record 1272. The total quantity of the resource type 422 tracked by the resource tracking computing device 200 may not have changed, only the quantities of the resource as recorded by resource records 1272 and 420 for the resource pools 252 and 242 may have changed. The resource pool 252 may be the source resource pool for the destination sub-transfer, may be controlled by the exchange participant that also controls the resource pool 1260 on the resource tracking computing device 1000, and may be stored as part of the exchange resource pools 250 in the storage 240 of the resource tracking computing device 200. The resource pool 242 may be the destination resource pool for the transfer.

The resource quantities 1274 and 424 may be counters stored in registers or memory cells. When the resource quantity 1274 is decremented, the quantity recorded by the counter may be decreased by the quantity specified in the linking sub-transfer. The resource quantities 1274 and 424 may also include locations or other identifiers for specific resources, such as those with physical instantiations such as commodities or block of memory, or financial instruments or other resources that may be individually distinguishable. This may allow the transfer of specific resources, such as specific commodities stored at specific locations, specific shares of stock, specific bonds, specific contracts such as, for example options contracts, and so on.

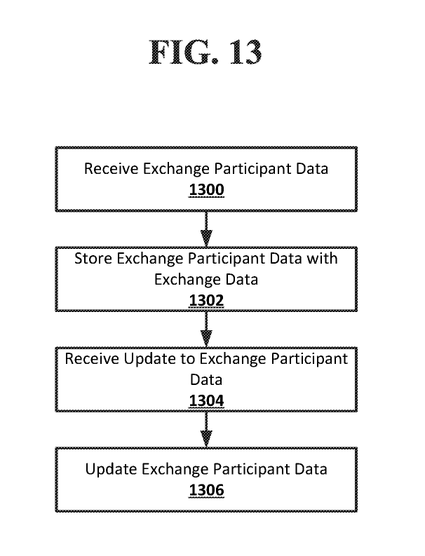

FIG. 13 shows an example procedure suitable for an exchange hosting server according to an implementation of the disclosed subject matter. At 1300, exchange participant data may be received. For example, the resource tracking computing device 200 may receive exchange participant data from an exchange participant computing device 100. The exchange participant data may be sent using the exchange manager client 110, and may be received at the exchange manager 220. The exchange participant data may include, for example, offered rates of exchange by the exchange participant associated with the exchange participant computing device 100 for various pairs of resources, and an identification of a resource pool controlled by the exchange participant on the resource tracking computing device 200, and an identification of resource pools controlled by the exchange participant on other resource tracking systems, such as, for example, the resource tracking computing device 1000.

At 1302, the exchange participant data may be stored with exchange data. For example, the exchange manager 220 may store the received exchange participant data as the exchange participant data 810 with the exchange data 260 in the storage 240 of the resource tracking computing device 200. The exchange data 260 may include exchange participant data received for multiple exchange participants.

At 1304, an update to the exchange participant data may be received. For example, the exchange manager client 110 may send an update to the exchange participant data 810, for example, changing offered rates of exchange for resource pairs or adding or removing identifications of resource pools controlled by the exchange participant on other resource tracking systems. The update may also be a request that the exchange participant data 810 be deleted or otherwise made inactive, as the exchange participant may wish to withdraw from the hosted exchange at the resource tracking computing device 200.

At 1306, the exchange participant data may be updated. For example, the exchange manager 220 may update the exchange participant data 810 in accordance with the update received from the exchange manager client 110, changing, adding, or removing data in the exchange participant data 810 as necessary. This may result in the exchange participant data 810 having updated rates of exchange between resource pairs, and updated identifications of resource pools controlled by the exchange participant on other resource tracking systems. The update may also result in the exchange participant data 810 being removed from the exchange data 260, for example, being deleted from the storage 240, or otherwise made inactive, if the update indicates that the exchange participant wishes to withdraw from the hosted exchange at the resource tracking computing device 200.

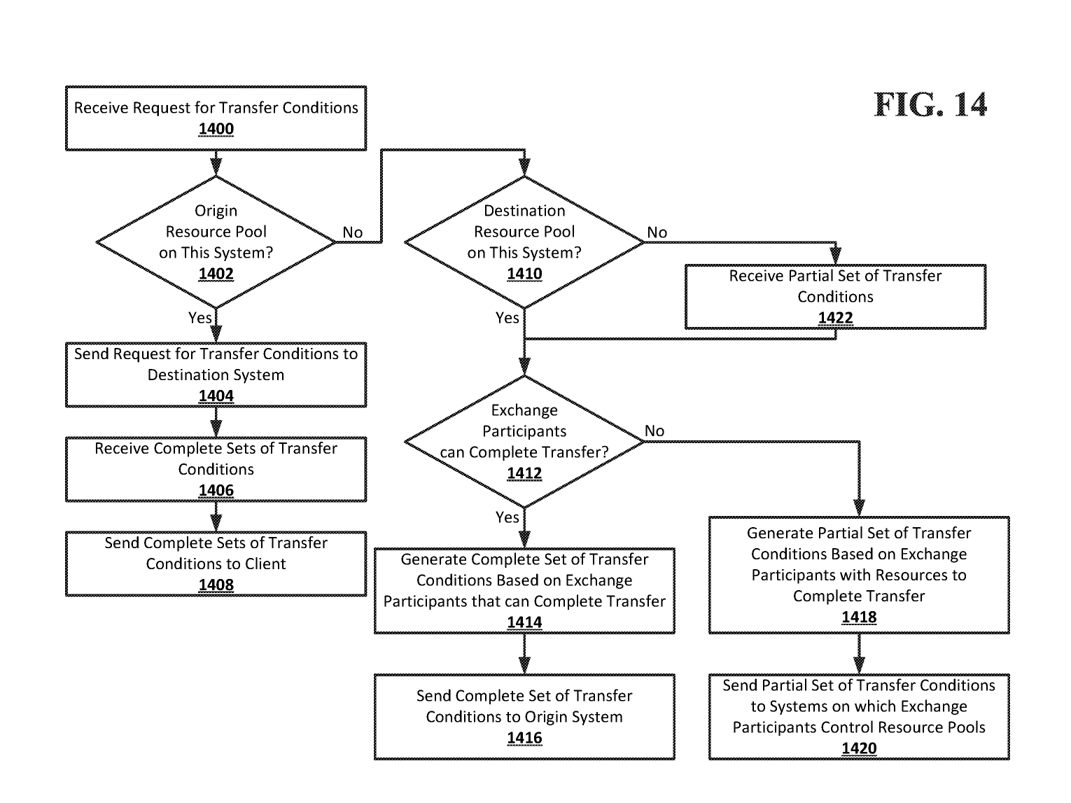

FIG. 14 shows an example procedure suitable for an exchange hosting server according to an implementation of the disclosed subject matter. At 1400, a request for transfer conditions may be received. For example, a request for transfer condition may be received by a resource tracking system, such as the resource tracking computing device 200, 700, 1000, 1010, and 1020. The request for transfer conditions may include any suitable data in any suitable format. For example, the request for transfer conditions may include an identification of the destination resource pool, an identification of the origin resource pool, and the amount and type of resource to be transferred into the destination resource pool.

At 1402, a resource tracking system that receives a request for transfer conditions may determine if it is the resource tracking system where the origin resource pool is located. For example, a resource tracking system, such as the such as the resource tracking computing device 200, 700, 1000, 1010, and 1020, may determine if it tracks the origin resource pool specified in the request for transfer conditions. If the resource tracking system determines that it is where the origin resource pool is located, flow proceeds to 1404. Otherwise, flow proceeds to 1410.

At 1404, the request for transfer conditions may be sent to the destination resource transfer system. For example, the resource tracking system may be the resource tracking computing device 700, and may have determined that it is the resource tracking system on which the origin resource pool is located, and is the origin resource tracking system for the transfer. The resource tracking computing device 700 may determine the destination resource tracking system for the transfer specified in the request for transfer conditions, which may be, for example, the resource tracking computing device 200. The resource tracking computing device 700 may send the request for transfer conditions to the resource tracking computing device 200.

At 1406, a complete set of transfer conditions may be received. For example, the resource tracking computing device 700 may receive a complete set of transfer conditions, including completed paths, from any resource tracking system, such as the resource tracking computing devices 200, 1000, 1010, and 1020, that was able to complete the set of transfer conditions based on the exchange participants at that resource transfer system.

At 1408, the complete set of transfer conditions may be sent to a client computing device. For example, the resource tracking computing device 700 may send the complete set of transfer conditions to the client computing device 300, where they may be received at the transfer client 310. This may allow the sending party to evaluate the paths in the completed set of transfer conditions, including the total cost of each path based on the exchange rates offered by the exchange participant at the resource transfer systems in the path and any fees imposed by the exchange participants or resource transfer systems.

At 1410, a resource tracking system that receives a request for transfer conditions and determines that it is not the origin resource tracking system may determine if it is the resource tracking system where the destination resource pool is located. For example, a resource tracking system, such as the such as the resource tracking computing device 200, 700, 1000, 1010, and 1020, may determine if it tracks the destination resource pool specified in the request for transfer conditions. If the resource tracking system determines that it is where the destination resource pool is located, flow proceeds to 1412. Otherwise, flow proceeds to 1422.

At 1412, a resource tracking system may determine whether its hosted exchange has any exchange participants which can complete the transfer. For example, a resource tracking system, such as any of the resource tracking computing devices 200, 700, 1000, 1010, and 1020 may determine if its hosted exchange has any exchange participants that can complete the transfer as specified in the request for transfer conditions, based on, for example, any exchange participant data stored as part of the exchange data on the resource tracking system. If the resource tracking system is the destination resource tracking system, it may determine if it can generate a complete path with both an origin and destination sub-transfer. If the resource tracking system is not the destination resource tracking system, it may determine if it can generate a complete path with an origin sub-transfer and a completely specified linking sub-transfer. If there is an exchange participant that can complete the transfer, flow may proceed to 1414. Otherwise, flow may proceed to 1418.

At 1414, a complete set of transfer conditions may be generated based on any exchange participants that can complete the transfer. For example, if the resource tracking system is the destination resource tracking system, it may generate, for each exchange participant that can complete the transfer, a path with an origin sub-transfer and destination sub-transfer. The rate of exchange may be set for each path based on the rate of exchange offered by the exchange participant which has its resource pools in the path. If the resource tracking system is not the destination resource tracking system, it may generate, for each exchange participant that can complete the transfer, paths with an origin sub-transfer, completely specified linking sub-transfers based on an incompletely specified linking sub-transfers from a partial transfer conditions, and a destination sub-transfer from the partial set of transfer conditions.

At 1416, the complete set of transfer condition may be sent to the origin resource transfer system. For example, the resource tracking computing device 700 may be the origin resource transfer system. The resource transfer system that has generated the complete set of transfer conditions, for example, the resource tracking computing device 200, 1000, 1010, or 1020, may send the complete set of transfer conditions back to the resource tracking computing device 700, which may in turn send them to, for example, the client computing device 300 for evaluation and selection of a path.

At 1418, a resource tracking system may generate a partial set of transfer conditions based on exchange participants with enough resources to complete the transfer. For example, a resource tracking system that determines that there are no exchange participants on its hosted exchange that can complete the transfer may not be able to generate a completed set of transfer conditions. The resource tracking system may instead generate, for each exchange participant that has enough resource on the resource tracking system to complete the transfer, incomplete paths. If the resource tracking system is the destination resource tracking system, it may generate for each such exchange participant incomplete paths with a destination sub-transfer and incompletely specified linking sub-transfers. If the resource tracking system is not the destination resource tracking system, it may generate for each such exchange participant incomplete paths with an incompletely specified linking sub-transfer, completely specified linking sub-transfers based on an incompletely specified linking sub-transfer in a received partial set of transfer conditions, and a destination sub-transfer from the received partial set of transfer conditions. The rate of exchange for each change of resource type in a path may be set for each incomplete path based on the rate of exchange offered by the exchange participant which has its resource pools in the path.

At 1420, the partial set of transfer conditions may be sent to resource tracking systems on which exchange participants control resource pools. For example, a resource tracking system may send a partial set of transfer conditions it has generated to any other resource tracking systems on which an exchange participant whose resource pools are used in the paths of the partial set of transfer conditions controls other resource pools. The other resource pools may be specified as the sink resource pools in incompletely specified linking sub-transfers of the incomplete paths in the partial set of transfer conditions. A resource tracking system may only be sent the paths in a partial set of transfer conditions that include, system as the sink resource pool of an incompletely specified linking sub-transfer, a resource pool located on that resource tracking. A resource tracking system that receives a partial set of transfer conditions may attempt to complete the set of transfer conditions.

At 1422, a partial set of transfer conditions may be received. For example, a resource tracking system which is not the origin or destination resource tracking system may have received the request for transfer conditions. The resource tracking system may also then receive a partial set of transfer conditions that was sent along with the request for transfer conditions, and may attempt to complete the partial set of transfer conditions based on the request for transfer conditions. Flow may proceed to 1412.

Embodiments of the presently disclosed subject matter may be implemented in and used with a variety of component and network architectures. FIG. 15 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 16.

Many other devices or components (not shown) may be connected in a similar manner, such as document scanners, digital cameras, auxiliary, supplemental, or backup systems, or the like. Conversely, all of the components shown in FIG. 15 need not be present to practice the present disclosure. The components can be interconnected in different ways from that shown. The operation of a computer such as that shown in FIG. 15 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 16 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method performed on a data processing apparatus comprising:
receiving, from a first computing device at a second computing device, a request for transfer conditions for a transfer of resources;
determining an exchange participant of a hosted exchange at the second computing device that can complete the transfer of resources;
generating a set of transfer conditions in response to the request for transfer conditions, the set of transfer conditions comprising a path comprising a first sub-transfer and a second sub-transfer, wherein the first sub-transfer comprises a transfer of a first resource type from a first resource pool to a second resource pool on the first computing device, and wherein the second sub-transfer comprises the transfer of a second resource type from a third resource pool to a fourth resource pool on the second computing device, and wherein the second resource pool and third resource pool are controlled by the exchange participant; and
sending the set of transfer conditions to the first computing device.

2. The method of claim 1, further comprising:
determining a rate of exchange for effecting a change from the first resource type to the second resource type from exchange participant data for the exchange participant, wherein the set of transfer conditions includes an indication of the rate of exchange.

3. The method of claim 1, further comprising:
receiving from a third computing device exchange participant data for an exchange participant; and
storing the exchange participant data with exchange data.

4. The method of claim 1, further comprising determining one or more other exchange participants of the hosted exchange that can complete the transfer of resources; and
for each one of the one or more other exchange participants that can complete the transfer of resources, adding, to the set of transfer conditions, a path for the one of the one or more other exchange participants comprising a first sub-transfer and a second sub-transfer, wherein the first sub-transfer comprises a transfer of the first resource type from a first resource pool to a second resource pool on the first computing device, and wherein the second sub-transfer comprises the transfer of the second resource type from a third resource pool to a fourth resource pool on the second computing device, and wherein the second resource pool and third resource pool are controlled by the one of the one or more other exchange participants.

5. The method of claim 4, further comprising determining a rate of exchange for effecting a change from the first resource type to the second resource type from exchange participant data for each of the one or more other exchange participants, wherein the set of transfer conditions includes an indication of the rates of exchange for each of the one or more other exchange participants.

6. The method of claim 1, wherein the second computing device is both an exchange hosting server and a resource tracking system.

7. The method of claim 1, further comprising:
receiving an update to exchange participant data for the exchange participant; and
updating the exchange participant data according to the received update.

8. A computer-implemented method performed on a data processing apparatus comprising:
receiving, from a first computing device at a second computing device, a request for transfer conditions for a transfer of resources;
determining that there is no exchange participant of a hosted exchange at the second computing device that can complete the transfer of resources;
determining an exchange participant that can complete a destination sub-transfer of the transfer of resources;
generating a partial set of transfer conditions in response to the request for transfer conditions, the partial set of transfer conditions comprising an incomplete path comprising an incompletely specified first sub-transfer and a second sub-transfer, wherein the incompletely specified first sub-transfer comprises a transfer of a first resource type from a first resource pool to a second resource pool on a third computing device wherein the first resource pool is not identified, and wherein the second sub-transfer comprises the transfer of a second resource type from a third resource pool to a fourth resource pool on the second computing device, and wherein the second resource pool and third resource pool are controlled by the exchange participant and the second resource pool is identified in exchange participant data for the exchange participant; and
sending the partial set of transfer conditions to the third computing device.

9. The method of claim 8, further comprising:
determining a rate of exchange for effecting a change from the first resource type to the second resource type from the exchange participant data for the exchange participant, wherein the partial set of transfer conditions includes an indication of the rate of exchange.

10. The method of claim 8, further comprising:
determining from the exchange participant data for the exchange participant one or more other identified resource pools controlled by the exchange participant on a computing device that is not the first computing device, the second computing device, or the third computing device;
for each one of the one or more other identified resource pools, generating an additional partial set of transfer conditions, the additional partial set of transfer conditions comprising an incomplete path comprising an incompletely specified first sub-transfer and the second sub-transfer, wherein the incompletely specified first sub-transfer comprises a transfer of the first resource type from a first resource pool to the one of the one or more other identified resource pools on a computing device on which the one of the one or more other identified resource pools is located, wherein the first resource pool is not identified, and wherein the second sub-transfer comprises the transfer of the second resource type from the third resource pool to the fourth resource pool on the second computing device, and wherein the one of the one or more other identified resource pools and third resource pool are controlled by the exchange participant; and
sending each additional partial set of transfer conditions to the computing device on which the one of the one or more other identified resource pools in the incomplete path of the partial set of transfer conditions is located.

11. The method of claim 8, wherein the second computing device is both an exchange hosting server and a resource tracking system.

12. The method of claim 8, further comprising:
receiving an update to exchange participant data for the exchange participant; and
updating the exchange participant data according to the received update.

13. A computer-implemented method performed on a data processing apparatus comprising:
receiving, from a first computing device at a second computing device, a request for transfer conditions for a transfer of resources and a partial set of transfer conditions comprising an incomplete path;
determining an exchange participant of a hosted exchange at the second computing device that can complete the transfer of resources;
generating a set of transfer conditions in response to the request for transfer conditions and partial set of transfer conditions, the set of transfer conditions comprising a path comprising a first sub-transfer, a second sub-transfer, and a third sub-transfer, wherein the first sub-transfer comprises a transfer of a first resource type from a first resource pool to a second resource pool on the first computing device and is specified in the incomplete path, wherein the second sub-transfer comprises the transfer of a second resource type from a third resource pool to a fourth resource pool on the second computing device, wherein the third resource pool is specified in an incompletely specified sub-transfer of the incomplete path, and wherein the third sub-transfer comprises a transfer of a third resource type from a fifth resource pool to a sixth resource pool on a third computing device wherein the fifth resource pool is specified in the request for transfer conditions, and wherein the third resource pool and sixth resource pool are controlled by the exchange participant; and
sending the set of transfer conditions to the third computing device.

14. The method of claim 13, further comprising:
determining a rate of exchange for effecting a change from the third resource type to the second resource type from the exchange participant data for the exchange participant, wherein the partial set of transfer conditions includes an indication of the rate of exchange.

15. The method of claim 13, wherein the second computing device is both an exchange hosting server and a resource tracking system.

16. The method of claim 13, further comprising:
receiving an update to exchange participant data for the exchange participant; and
updating the exchange participant data according to the received update.

17. A system comprising: one or more computers and one or more storage devices storing instructions which are operable, when executed by the one or more computers, to cause the one or more computers to perform operations comprising:
receiving, from a first computing device at a second computing device, a request for transfer conditions for a transfer of resources;
determining an exchange participant of a hosted exchange at the second computing device that can complete the transfer of resources;
generating a set of transfer conditions in response to the request for transfer conditions, the set of transfer conditions comprising a path comprising a first sub-transfer and a second sub-transfer, wherein the first sub-transfer comprises a transfer of a first resource type from a first resource pool to a second resource pool on the first computing device, and wherein the second sub-transfer comprises the transfer of a second resource type from a third resource pool to a fourth resource pool on the second computing device, and wherein the second resource pool and third resource pool are controlled by the exchange participant; and
sending the set of transfer conditions to the first computing device.

18. A system comprising: one or more computers and one or more storage devices storing instructions which are operable, when executed by the one or more computers, to cause the one or more computers to perform operations comprising:
receiving, from a first computing device at a second computing device, a request for transfer conditions for a transfer of resources;
determining that there is no exchange participant of a hosted exchange at the second computing device that can complete the transfer of resources;
determining an exchange participant that can complete a destination sub-transfer of the transfer of resources;
generating a partial set of transfer conditions in response to the request for transfer conditions, the partial set of transfer conditions comprising an incomplete path comprising an incompletely specified first sub-transfer and a second sub-transfer, wherein the incompletely specified first sub-transfer comprises a transfer of a first resource type from a first resource pool to a second resource pool on a third computing device wherein the first resource pool is not identified, and wherein the second sub-transfer comprises the transfer of a second resource type from a third resource pool to a fourth resource pool on the second computing device, and wherein the second resource pool and third resource pool are controlled by the exchange participant and the second resource pool is identified in exchange participant data for the exchange participant; and
sending the partial set of transfer conditions to the third computing device.

19. The system of claim 18, wherein the instructions which are operable, when executed by the one or more computers, further cause the one or more computers to perform operations comprising:
determining a rate of exchange for effecting a change from the first resource type to the second resource type from the exchange participant data for the exchange participant, wherein the partial set of transfer conditions includes an indication of the rate of exchange.

20. The system of claim 18, wherein the instructions which are operable, when executed by the one or more computers, further cause the one or more computers to perform operations comprising:
determining from the exchange participant data for the exchange participant one or more other identified resource pools controlled by the exchange participant on a computing device that is not the first computing device, the second computing device, or the third computing device;
for each one of the one or more other identified resource pools, generating an additional partial set of transfer conditions, the additional partial set of transfer conditions comprising an incomplete path comprising an incompletely specified first sub-transfer and the second sub-transfer, wherein the incompletely specified first sub-transfer comprises a transfer of the first resource type from a first resource pool to the one of the one or more other identified resource pools on a computing device on which the one of the one or more other identified resource pools is located, wherein the first resource pool is not identified, and wherein the second sub-transfer comprises the transfer of the second resource type from the third resource pool to the fourth resource pool on the second computing device, and wherein the one of the one or more other identified resource pools and third resource pool are controlled by the exchange participant; and
sending each additional partial set of transfer conditions to the computing device on which the one of the one or more other identified resource pools in the incomplete path of the partial set of transfer conditions is located.
